(19) United States
(12) Patent Application Publication
(10) Pub. No.: US 2016/0155475 A1
(43) Pub. Date: Jun. 2, 2016

(54) Method And System For Capturing Video From A Plurality Of Devices And Organizing Them For Editing, Viewing, And Dissemination Based On One Or More Criteria

(71) Applicant: CrowdFlik, Inc., Westport, CT (US)

(72) Inventor: Christopher Hamer, Westport, CT (US)

(21) Appl. No.: 15/017,521

(22) Filed: Feb. 5, 2016

Related U.S. Application Data
(63) Continuation-in-part of application No. 14/844,471, filed on Sep. 3, 2015.
Application No. 14/844,471 is a continuation of application No. 14/103,541, filed on Dec. 11, 2013, now Pat. No. 9,129,640.
(60) Provisional application No. 61/736,367, filed on Dec. 12, 2012.
(60) Provisional application No. 61/790,066, filed on Mar. 15, 2013.
(60) Provisional application No. 61/760,129, filed on Feb. 3, 2013.

(51) Int. Cl. G11B 27/034; G11B 27/32; G11B 31/00; H04N 21/472; H04N 21/854; H04N 21/845; H04N 21/218; H04N 21/414; G11B 27/10; H04N 5/76

(52) U.S. Cl. CPC G11B 27/034; G11B 27/102; G11B 27/32; G11B 31/006; H04N 5/7605; H04N 21/854; H04N 21/8456; H04N 21/21805; H04N 21/41407; H04N 21/47205

(57) ABSTRACT

The disclosed embodiments allow for the capturing, synchronization, editing of video clips captured by a plurality of devices. The disclosed embodiments allow for video clips to be organized and disseminated to users in a way that logs the content provide to each user, the date it was provided, and the original source of all included content. Video clips can be organized by one or more criteria, including source, date and time, physical location where the video was captured, the presence of certain images such as a particular face, or the presence of certain sounds such as a voice.

### CROSS-REFERENCE TO RELATED APPLICATIONS

This application is a continuation-in-part of U.S. patent application Ser. No. 14/844,471, filed on Sep. 3, 2015, and titled “Method and System for Capturing, Synchronizing, and Editing Video From a Primary Device and Devices in Proximity to the Primary Device,” which is a continuation of U.S. patent application Ser. No. 14/103,541, filed on Dec. 11, 2013, and titled “Collaborative Digital Video Platform That Enables Synchronized Capture, Curation and Editing of Multiple User-Generated Videos,” issued as U.S. Pat. No. 9,129,640 on Sep. 8, 2015, which claims priority from U.S. Patent Application Nos. 61/736,367 filed on Dec. 12, 2012, 61/760,129 filed on Feb. 3, 2013, and 61/790,066 filed on Mar. 15, 2013, each of which is incorporated herein by reference.

### FIELD OF THE DISCLOSURE

The present disclosure relates generally to capturing video from a plurality of devices, storing extensive metadata for the video, synchronizing the video, allowing a user to collect video clips using certain criteria (such as location or time), creating a video file containing the video clips of interest, viewing the video file, and disseminating the video file. The system optionally can perform facial recognition and sound recognition automatically on some or all of the video clips so that the criteria can include the names of people and sounds.

### BACKGROUND

With the global proliferation of video enabled mobile devices, consumers capture and upload millions of videos each week. Often, numerous videos of events are posted, sometimes numbering in the hundreds for popular events such as concerts, sporting events and other public occasions. These amateur videos often are of uneven quality and length, and with a large number of websites in which to post a video, it is hard for consumers to know where to find a video of an interest of a certain topic or location.

In addition, in the prior art the labeling or tagging of a submitted video is left to the submitter and is not subject to any standards for grouping or searching. The ability to sort through this mass of video content is nearly impossible.

There is also no method to easily combine multiple videos that are captured of a particular event. Further, there is no simple way to edit those multiple videos into a single video or into a video of multiple best-of edits. Traditional film edit tools are expensive and hard to use. Further, the output is typically a single edited version based on the editor's determination of best edit. There is no consumer friendly way to create individual edits of a video, or to create and/or view an edit of a film that is a result of the wisdom of the crowd throughout the video. Other websites have created “black box” scene selectors to combine videos, but this typically results in videos of limited value, and fails to engage the crowd in the creation and edit process.

There is also no method available to consumers to enable the sharing and collaboration on video in a “private” environment that allows a limited subset of users (such as users who have been invited by an originator) to access videos and contribute videos. There is also no simple way for each individual to make his own video version or edit of an event that has been filmed by multiple cameras or smart phones during the event. There also is no method for synchronized capture and review of multiple angles from multiple locations to use for security review and entertainment. The wisdom of the “crowd” and the needs of the individual have been largely ignored in the various attempts to combine multiple amateur video submissions.

In another aspect of the prior art, the capturing, organizing, viewing, and dissemination of video clips by law enforcement agencies has been particularly cumbersome. To date, there has been no easy way to capture and organize video collected from a variety of sources using non-synchronized clocks, and organizing those videos has involved tedious work by a person using prior art video editing software. There also is no acceptable mechanism for creating a video collection for dissemination to people outside of the law enforcement agency (e.g., the press) and to capture data regarding what video was collected, to whom it was given, and when it was given. What is needed is an improved system and method for capturing, organizing, and disseminating video in the law enforcement context.

### BRIEF SUMMARY OF THE INVENTION

The embodiments described herein utilize an application (“app”) known as “CROWDFLIK.” CROWDFLIK is preferably implemented as an app for mobile devices, such as smartphones and tablets. It also can be implemented as an app for desktops, notebooks, or any other device that can capture video and run a software application. The app works in conjunction with a server, accessible over the Internet, which together facilitate the synchronized capture, synchronized grouping, multiple user edit, crowd curation, group and individual viewing, multiple edits and sharing of video edits and clips.

The CROWDFLIK app allows each user to activate and/or accept a location/event confirmation, or check-in, in order to activate the capture and submit video function of the CROWDFLIK app which tags or marks each submitted video with location specific data, allowing proper grouping for synchronized review and edit. During the video capture and submission process, the CROWDFLIK mobile app activates a unique process of synchronized tagging, or cutting, of the video at synchronized Y second increments according to the CROWDFLIK app's master clock, where Y is the length, typically measured in seconds, of each sub-segment of submitted video. The captured videos are cut at synchronized Y second intervals. Typically, only full Y second segments are submitted to the CROWDFLIK app's Review/Edit platform. The segments are then grouped and synchronized on the CROWDFLIK Review/Edit platform for user combination, editing, review, sharing, tagging, re-editing, saving, and more based on the location/time tag.

The CROWDFLIK Review/Edit platform allows users to review all video submissions that have been combined and synchronized for each location/time (e.g., event). The CROWDFLIK app Review/Edit platform allows users to review and edit the multiple submissions to create unique video edits of the event. The CROWDFLIK app allows for a seamless resynchronization of the series of segments selected by the user resulting in his or her own personal edit. A user is permitted to select a subset of the entire event video in order to create and save shorter videos that are a subset of the overall video based on selecting submission for each successive time segment of Y second(s). The aggregate of the individual selections determines a ‘best of’ selection for each Y second(s) segment which in turn determines the crowd curated best-of edit based on the CROWDFLIK curation algorithm.

One benefit of these embodiments is that a user can generate a video of an event using segments that were captured from different devices at the event. Unless an event is designated as private or is otherwise restricted, any user with access to the CROWDFLIK app may review, create edits, share, and upload filks regardless of whether they attended the original event.

### BRIEF DESCRIPTION OF THE DRAWINGS

FIG. 1A is a flow chart illustrating a typical CROWDFLIK account set up and log-in process;

FIG. 1B is a flow chart illustrating a typical event setup;

FIG. 1C is a flow chart illustrating a typical video capture and submission;

FIG. 1D is a flow chart illustrating a typical setup of a private event;

FIG. 2 is a block/flow diagram illustrating an exemplary video capture and submission process of the present system and methods, including the location/date/time tagging and video capture/tag/submission process;

FIG. 3 is a pictorial diagram illustrating an exemplary screen shot of the CROWDFLIK video capture process on a typical smart device having a video capture function;

FIG. 4 is an exemplary screen shot of a Review/Edit screen of the present systems, methods, and computer-accessible mediums with annotations;

FIG. 5A illustrates the review/edit functionality where users are enabled to select a video segment and drag to a timeline;

FIG. 5B illustrates the review/edit functionality where users are enabled to select a video segment and an audio segment and drag to a timeline

FIG. 6 represents a screen flow enabling a user to follow other CROWDFLIK users and their edits, to perform event check-ins, and to engage in other shared activity;

FIG. 7 details the screen flow of the capture function in the capture state and the ready state;

FIG. 8 illustrates the screen flow where users are able to tag and share edits;

FIGS. 9A and 9B illustrate the screen flow enabling users to join an event or create an event in which to use the app to capture video; and

FIG. 10 is an illustration of an exemplary block diagram of an exemplary system in accordance with certain exemplary embodiments of the present disclosure.

FIG. 11 illustrates video captured of an event from a plurality of devices.

FIG. 12 illustrates an event comprising video captured from devices at different locations.

FIG. 13 depicts an embodiment involving geofencing.

FIG. 14 depicts an embodiment for generating crowd curated video and audio clips.

FIG. 15 depicts an embodiment of a trending method.

FIG. 16 depicts an exemplary data structure for a video or audio segment.

FIG. 17 depicts an exemplary data structure for a video or audio clip.

FIG. 18 depicts various hardware and software components used in the embodiments.

FIG. 19 depicts a method for image recognition and voice recognition.

FIG. 20 depicts other metadata that can be captures or created for a video or audio clip

FIG. 21 depicts a plurality of cameras used to capture video in a law enforcement context.

FIG. 22 depicts a plurality of cameras used to capture video at a particular time and location.

FIG. 23 depicts the identification of video clips containing a particular face that is recognized in video clips using known facial recognition techniques.

FIG. 24 depicts a mechanism for pixelating a face in a video or image to obfuscate the identity of the person depicted.

FIG. 25 depicts data structures that are created for a video/audio clip that is assembled from a plurality of segments of video/audio and disseminated.

### DETAILED DESCRIPTION OF PREFERRED EMBODIMENTS

In a preferred embodiment, CROWDFLIK is a mobile app for use on mobile devices, such as smartphones, tablets, and the like, that works in conjunction with an Internet platform that facilitates uploading, downloading, and encoding for a variety of device platform playback, as well as coding for a variety of security and privacy preferences. The mobile app and Internet platform also facilitate the synchronized capture, synchronized grouping, distributed reviewing, crowd curation, group and individual viewing, multiple edits and sharing of edited video clips.

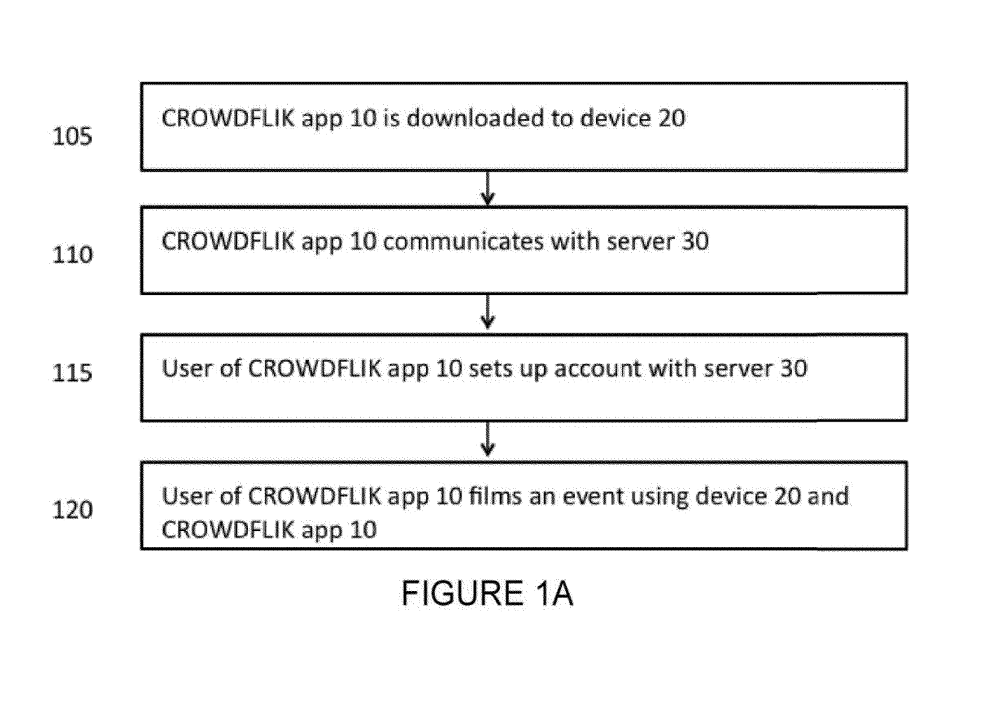

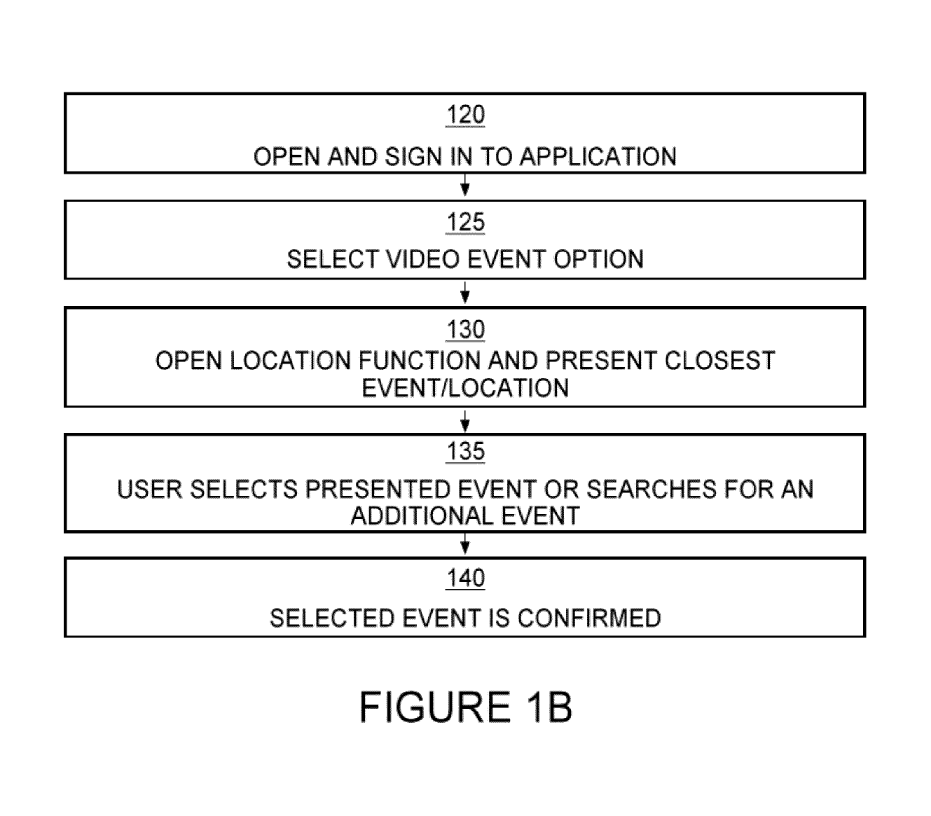

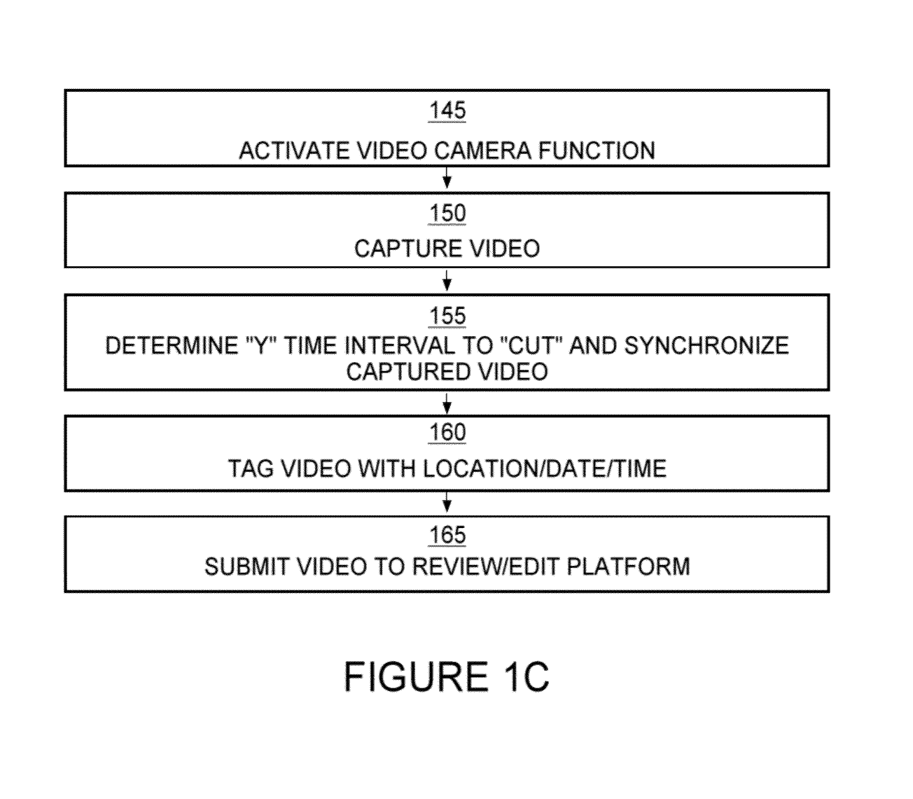

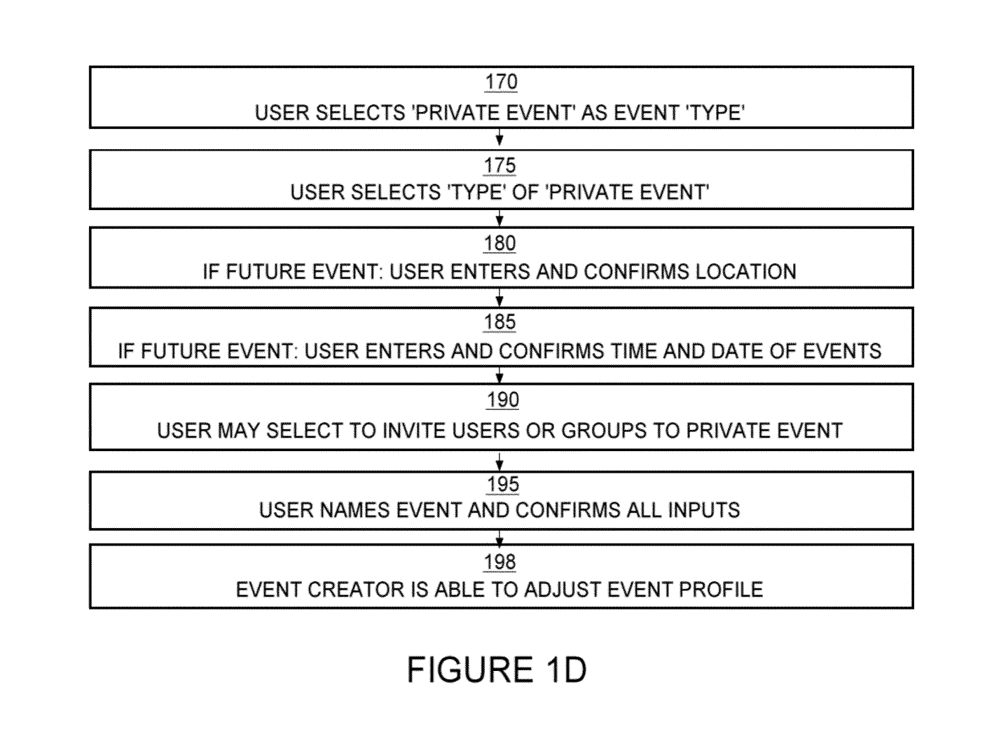

FIG. 1A is a flow chart illustrating a typical CROWDFLIK account set up and log-in process. Preferably, the CROWDFLIK app 10 is downloaded to a user's device 20 at step 105, and the app 10 thereafter resides on device 20. At step 110, app 10 establishes communication with server 30. Private and secure Internet connections are supported. Connectivity with server 30 can be activated or deactivated on device 10 in order to save the battery life of device 10. The connectivity can be accomplished using any known networking technology, including local area and wide area networks, Wi-Fi, Wi-MAX, COMS, 3G 4G, LTE and the like.

In order to use the CROWDFLIK app 10 video capture function, the user will set up an account with server 30 (FIG. 1A, step 115), such as by creating a unique User ID and password, and entering basic identifying information such as an email address. The app 10 permits users to create and maintain multiple accounts by connecting their CROWDFLIK accounts with their accounts at other popular social media sites such as Facebook, Twitter, Google+. The app 10 also allows users to combine their multiple accounts into a single account. Once the user has created an account, and logged into the CROWDFLIK app 10 and/or server 30, the user can begin filming an event at step 120. When the CROWDFLIK app 10 is activated, it preferably opens and operates along with the native video camera function of device 20.

FIG. 1B is a flow chart illustrating a typical event setup. When a user wants to use the video capture function of app 10, the user opens or activates the CROWDFLIK mobile app 10, and signs in to his account within the app 10 at step 120. The user then selects the option to capture an event at step 125. This begins the check-in process. The app 10 utilizes the native video function of device 20. The CROWDFLIK app 10 can gather location information from device 20 to assure proper placement of the submitted video at the Review/Edit platform of CROWDFLIK. This is achieved using a combination of the global positioning system (“GPS”) or other location function of device 20, other social media applications where permitted, and custom application functionality for devices that can utilize such custom modules.

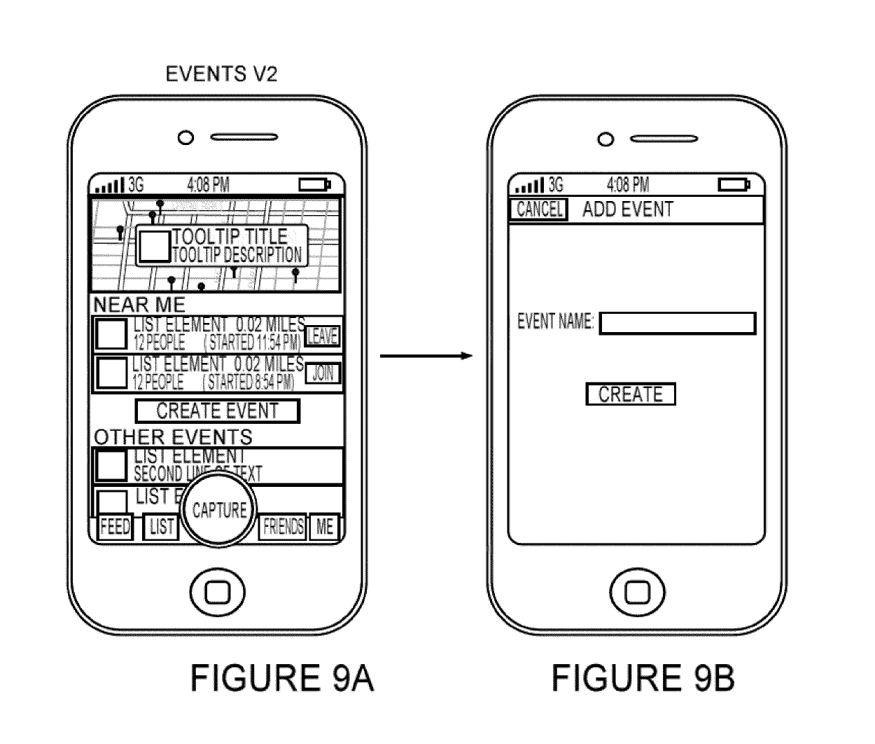

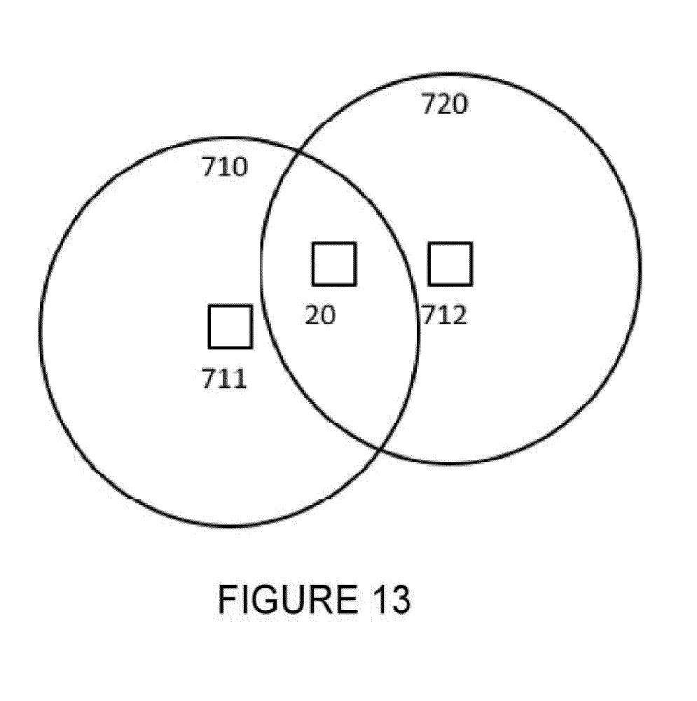

As illustrated in step 130, and in FIGS. 9A and 9B and 13, during the check-in process, the user is presented with a list of CROWDFLIK events that are within a predetermined geofence in which the user is located, and have already been initiated by other users. As illustrated in FIGS. 9A and 9B, the available events can by depicted graphically, such as on a map, or in list form showing events that are close to the user or events that may be of interest to the user. Events that a user may join optionally can be identified by determining within which event geofences the user is located. With reference to FIG. 13, device 711 has created an event. The creation of the event includes the establishment of geofence 710, which in this example is a circle of radius R from the location of device 711. Here, another geofence 720 is established around device 712 after device 712 establishes another event. R can be set to any value, such as 50 feet or 500 feet depending on the type of event in question (e.g., a school music concert v. a rock concert). If device 20 wishes to join an event, server 30 will notify it about the events created by devices 711 and 712 because device 20 in this example is within geofence 710 and geofence 720.

With reference again to FIG. 1B, at step 135, if the event that the user wants to capture using the CROWDFLIK app 10 is listed, then the user can select the pre-identified event; if the event is not listed, then the user can search for an additional event or add (e.g., create) a new event by accepting the location and giving the event a name. This is shown, for example, in FIG. 9B which illustrates an exemplary screen display after a user selects the Create Event button in FIG. 9A. When a user creates an event, he/she is the event creator and may select event attributes such as privacy status and event end time and may edit these attributes at future times. Other users who are at the same event may subsequently join the newly created event. After a previous event has been selected, or a new event has been created, the selected event is confirmed at step 140.

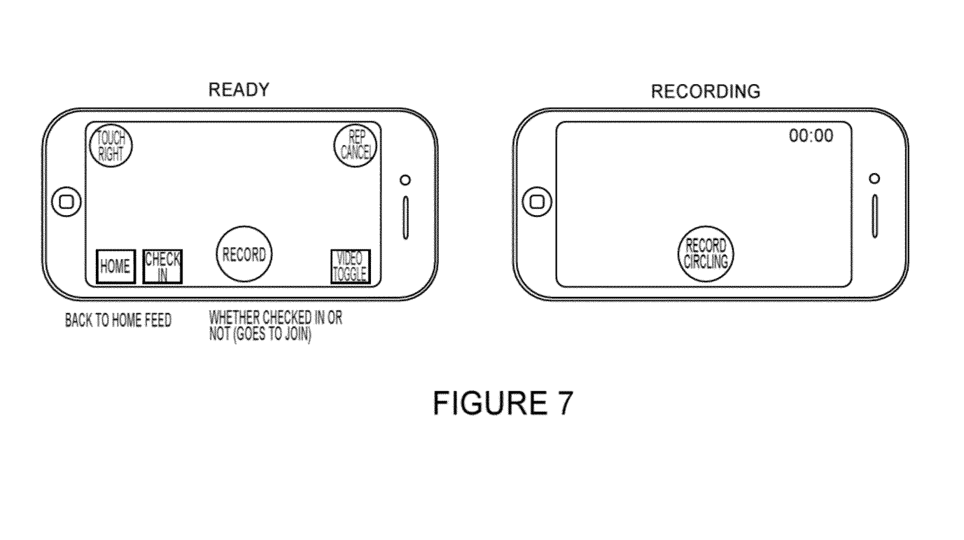

Once the event has been confirmed, the user can begin filming or recording the event (e.g., FIG. 1C and FIG. 7). For example, the user can select begin capture on the CROWDFLIK app 10, and the CROWDFLIK app 10 can activate the device 20's video camera function at step 145. Once the CROWDFLIK app 10 is activated for video capture, it initiates a location check-in function using a combination of the device's native location determination functionality and wireless access and other tri-angulation methods available including, but not limited to Wi-Fi, WiMAX, most recent position, cellular signal, global positioning system (“GPS”) signal, blue tooth, near field communications, sonic tone, quick response (“QR”) code and/or Bar code to give the user the ability to initiate a check-in process used for submitting video to the CROWDFLIK review/edit platform.

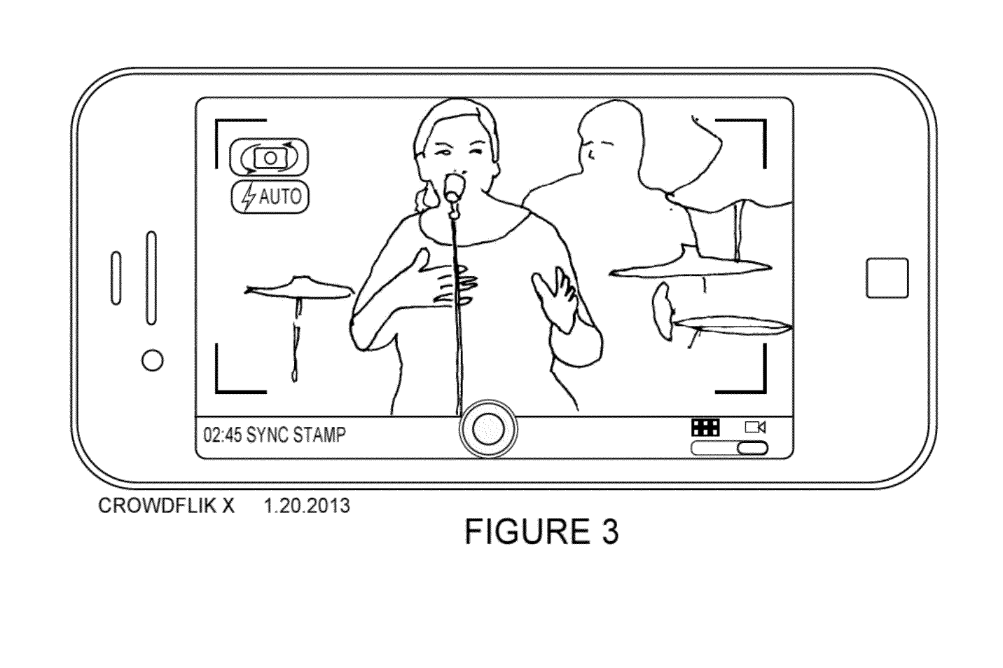

At step 150, the CROWDFLIK app 10 can begin capturing the video (see also FIG. 3). At random or predetermined time intervals during capture, in the background, the CROWDFLIK app 10 can check to confirm that the current location of the device is consistent with the previously submitted and tagged location. In the case of a discrepancy, as determined for example using an algorithm based on a combination of geo-fencing data based on the initial location of the device that created the event and location data of device 10, the user will receive a notification (e.g., a pop up window-type notification) asking the user to reconfirm the location. The subsequent video will be tagged with the revised location data, if necessary.

In another embodiment, an event is created based on the participants involved rather than on location information, which allows the selected or invited devices to be synchronized over a period of time regardless of location. In another embodiment, a first user may create a personal event where his or her device is the center of the event. As the first user moves, other users in proximity of the first user may join the event, thereby capturing and contributing synchronized video to the first user's event. This can be useful, for example, if the user is sightseeing or engaged in other physical movement.

In another embodiment, a first user may create a personal event where his or her device is the center of the event. As the first user moves, video/audio captured by other users within a certain geofence of the first user automatically are added to the event, thereby capturing and contributing synchronized video to the first user's event. This can be useful, for example, if the user is sightseeing or engaged in other physical movement. For example, if a user runs a marathon and films a portion of the marathon, the user will later have access to video/audio captured by other users who were within the geofence of that user as he or she moved. The user can then create a video/audio clip (flik) that contains video/audio from other users whom the user does not even know or interact with.

The CROWDFLIK app 10 preferably synchronizes all devices at any given event that are using the CROWDFLIK 10 app to capture video, and that have selected the specific event.

However, in case multiple instances of the event are separately created by multiple users, the CROWDFLIK app 10 and server 30 can synchronize these multiple instances at a later time.

In one embodiment, the CROWDFLIK app 10 can incorporate a clock algorithm that uses the Internet or other network functionality to connect with a known, reliable clock 40 such as the US Naval Atomic clock to determine the difference between the Atomic time and the time code of each individual device. The Naval Atomic clock can then serve as the CROWDFLIK master clock, and all time stamping and coding can be referenced to this master clock. The CROWDFLIK app 10 can then apply a “time-delta” to each device based on the difference between the clock of device 20 and the master clock. Preferably, the “time-delta” can be applied as Meta tags to each video segment captured and uploaded by the CROWDFLIK app 10 for future review, edit and sharing.

Alternatively, in a peer-to-peer time embodiment, the device of the creator or another user can serve as the master clock, and all other devices who join the same event will synchronize to that clock. Thereafter, each device that has synchronized to the master clock can serve as additional master clocks for new devices that join the event.

In another embodiment, instead of time synchronization, video streams can be synchronized based on sound or images. For example, if two different devices capture video streams of an event, even if they are not synchronized to a master clock or to each other, the captured video can still be synchronized based on image recognition performed on the video streams or based on sound detection performed on the audio streams associated with the video streams. This would be particularly accurate, for example, for synchronizing multiple captures of a speech, rock concert, sporting event, etc.

When video is captured, the CROWDFLIK app 10 determines time intervals of duration “Y” to cut and synchronize the captured video at step 155. Y can be, for example, 5 seconds, 10 seconds, or any desired duration. Each Y second(s) segment of the video is tagged and/or marked at step 160 with the location data determined from the check-in, and the time data as determined by the app's master clock. The captured video can be submitted to server 30 at step 165, and all video submissions can be tagged and/or marked with time/date/location for synchronized display and edit at the proper section of the Review/Edit platform in order for videos to be placed in a synchronized fashion with other videos from like events. In certain embodiments, the app may allow users to select different values for “Y” to review and edit video. Users may select shorter or longer lengths of the segments depending on the user's needs at the time they are creating fliks. Users may also select varied time segments for their creative purposes.

The CROWDFLIK app time tagging at pre-selected, uniform intervals of Y seconds is utilized to assure the seamless re-synchronization of users' preferred video segment for each time slot.

A video captured via the CROWDFLIK app is “cut” or marked at Y second intervals. Typically, the length of time that represents Y for each segment is predetermined by the app, and is applied on a consistent basis to all video segments captured and uploaded via the CROWDFLIK app at a given event. Preferably, only full Y second(s) segments are submitted. For example, if a user begins to capture video in between the Y second(s) segments, the first video segment prior to the start of the next Y second(s) segment may be incomplete, and may not be submitted to the Review/Edit platform depending on rules that the CROWDFLIK app is applying at that time to the video captured at that event. Alternatively, the incomplete segment may be padded at the beginning of the segment with blank video content to extend the segment to a full Y second clip. A similar process may take place when the video capture ends after Y second(s) but before a subsequent Y second(s) where only the full Y second(s) segments may be uploaded to the platform. In one embodiment, all of the user's video is uploaded to the server, and only segments that are Y seconds (i.e., full clips) are presented during the review and edit process. In another embodiment, the user can decide whether segments that are less than Y seconds in duration should be uploaded to the server.

The video captured by the device 20 running CROWDFLIK 10 is saved on the device 20 in its entirety in the conventional manner that is determined by the device. In other words, as the video is processed and submitted by the CROWDFLIK app 10, it is simultaneously saved on device 20 in an unprocessed and uncut form according to the host device standards. The various video segments captured via the CROWDFLIK app 10 from the various users are then grouped and synchronized according to location/time/event tags on the CROWDFLIK Review/Edit platform for subsequent multiple user edit, review, sharing and saving. In the alternative, CROWDFLIK app 10 permits the user to opt out of saving all video to device 20 in the settings function if the user wants to upload only to CROWFLIK app 10 and server 30.

A user can capture video of any length via the CROWDFLIK app 10 for submission to the CROWDFLIK Review/Edit platform. The CROWDFLIK app 10's unique location/time tagging functionality at the time of video capture allows for proper grouping and synchronization, and gives the user robust search functionality.

The CROWDFLIK app 10 allows multiple simultaneous videos from multiple devices to be captured and uploaded via the CROWDFLIK app 10 to be viewed and edited, and can be grouped according to the location/time tagging.

With reference to FIG. 1D, a method of establishing a private event is depicted. The user selects “private event” as the event type using device 20 (step 170). The user selects the type of private event (step 175). If the type is a future event, the user enters and confirms the location of the private event (step 180). If the type is a future event, the user confirms the creation of the event (step 185). The user optionally selects users or groups to invite to the private event (step 190). Optionally, the user can establish a password to enable users to join the private event. The user names the event and confirms all inputs (step 195). Thereafter, the event creator is able to adjust the event profile (step 198). The name of the event can be significant. For example, if an advertiser or sponsor can set up a future event and put its name in the name of the event, such as “Company X Presents Rock Concert Y.” Thereafter, all actions associated with that event, such as the actions described herein, will trigger the use or display of that name, and Company X will obtain a brand promotion and advertising benefit from the usage, long after the event itself is over.

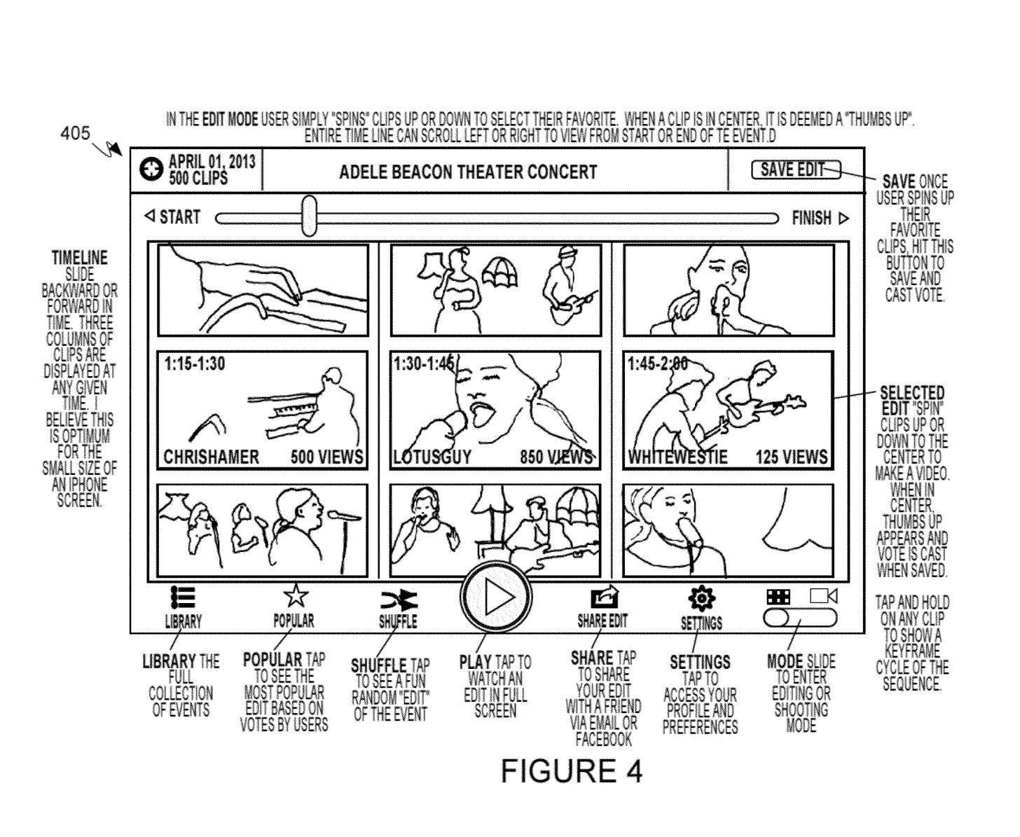

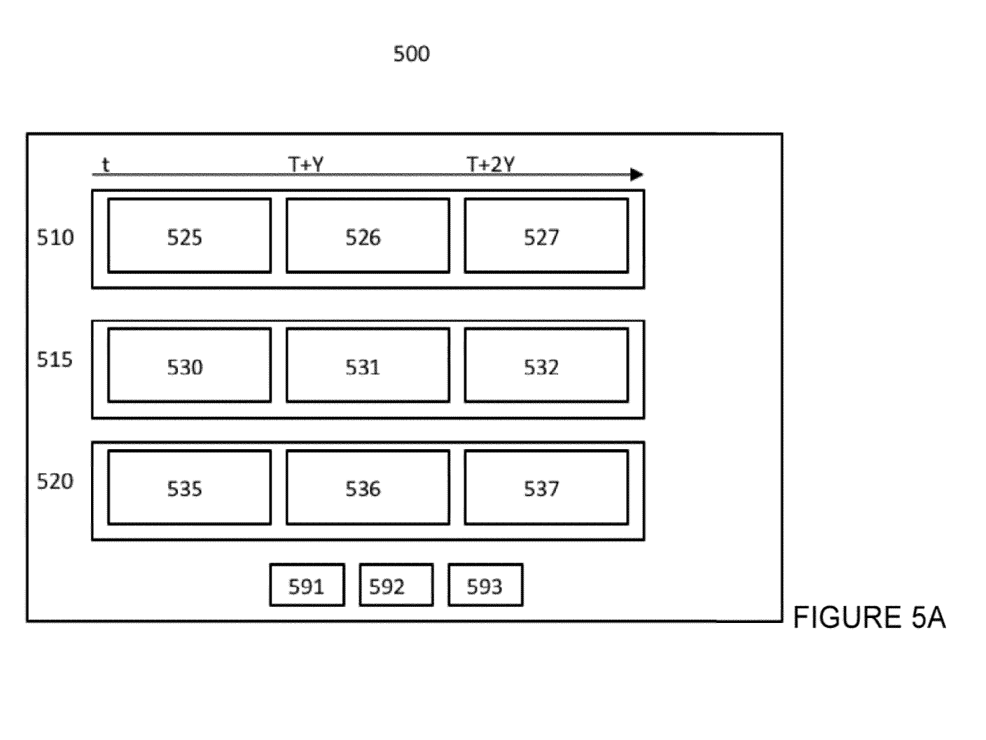

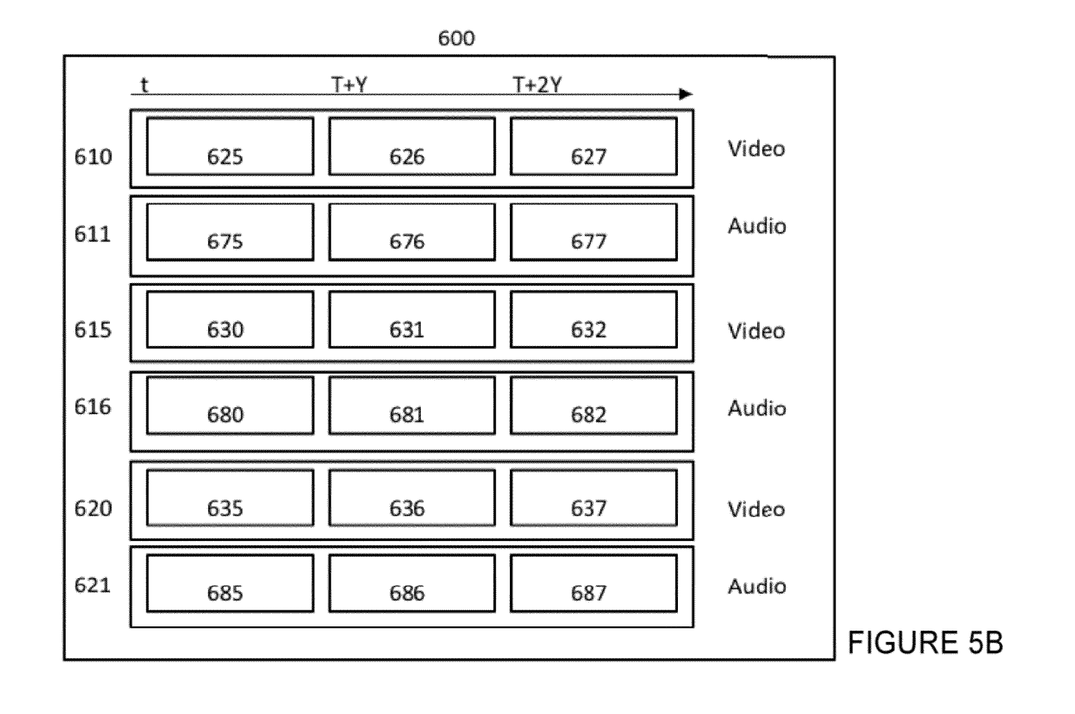

The Review/Edit platform 500, which is illustrated in FIGS. 4 and 5, is accessible via the CROWDFLIK app 10 as well as a website provided by server 30. For example, the Review/Edit platform 500 can be displayed on device 20 or on any computer or device with Internet access.

Referring to FIG. 5A, the Review/Edit platform 500 provides a graphical user interface (“GUI”) that may include a segmented timeline 510 which will accept and display the user selected segments to create the user edit. The Review/Edit platform 500 can also provide windows to illustrate the available segmented video streams for an event, such as video streams 515, and 520. Timeline 510 is partitioned into Y long segments 525, 526, and 527. Each segment begins at a certain time based on the master clock. In this example, the first segment begins at time t, and second segment at time t+Y, the third segment at time t+2Y, etc Similarly, video stream 515 is partitioned into Y long segments 530, 531, and 532, with segment 530 beginning at time t, segment 531 beginning at time t+Y, and segment 532 beginning at time t+2Y. Video stream 520 is partitioned into Y long segments 535, 536, and 537, with segment 535 beginning at time t, segment 536 beginning at time t+Y, and segment 537 beginning at time t+2Y

For example, if Y is 60 seconds and t is 5:00 p.m., segments 525, 530, and 535 would begin at 5:00 p.m., segments 526, 531, and 536 would begin at 5:01 pm, and segments 527, 532, and 537 would begin at 5:02 pm, etc. For illustration purposes, only three segments are shown for timeline 510 and video streams 515 and 520, but one of ordinary skill in the art will appreciate that segments of any number can be used.

A user can roll vertically through the available segments within each time slot of Y duration, and can select and place segments from any available video 515, and 520 and all additional video uploaded to the platform timeline 510, to create a user customized video of the event. Each segment selected from video 515, 520, or other video can only be placed in the timeline 510 at the location corresponding to the location on the timeline. For example, if segment 526 begins at 5:01 pm, only segments from video 515, 520, or other video that also begin at 5:01 pm can be placed in segment 526, in this example, segments 531 and 536. This ensures temporal synchronization from all video streams.

Review/Edit Platform 500 optionally can include input devices 591, 592, 593, and others to perform certain functions. For example, input device 591, when selected, can generate a screen shot capture of a shot within a video 510, 515, or 520 and allow the user to then download (for example, as a JPEG file) or view a still image of that shot. This allows an easy way for a user to obtain a photo from a video.

A variation of the embodiment of FIG. 5A is shown in FIG. 5B. In FIG. 5B, Review/Edit platform 600 provides a GUI that may include a segmented video timeline 610 which will accept and display the user selected video segments to create the user video edit. However, FIG. 5B also provides segmented audio timeline 611 which will accept and play the user selected audio segments to create the user audio edit. The Review/Edit platform 600 can also provide windows to illustrate the available segmented video streams for an event, such as video streams 615 and 620, as well as the available segmented audio streams for an event, such as audio streams 616 and 621. Timelines 610 and 611 are partitioned into Y long segments 625, 626, 627 and 675, 676, 677, respectively. It will be understood that many other video and audio streams can be present, and timelines 610 and 611 can extend well beyond three segments. In this example, video stream 615 and audio stream 616 were captured by a first device, and video stream 620 and audio stream 621 were captured by a second device. Unlike in FIG. 5A, however, the system of FIG. 5B allows the editor to decouple the video stream from the audio stream so that the editor can choose the video captured by one device and the audio captured by a different device. That is, if the editor chooses a segment from video stream 615, he or she can pick the corresponding segment in audio stream 616 or instead can pick the corresponding segment in audio stream 621 or another audio stream. The user can roll vertically through the available video and audio segments and make selections within each time slot of Y duration in the same manner described for FIG. 5B.

In one embodiment, all video uploaded to server 30 is tagged and marked for future organization on the Review/Edit Platform 500 or 600. CROWDFLIK app 10 and/or server 30 can restrict access to any uploaded video or part thereof based on location and time coding. For example if a performer decides to not allow his or her performance on the CROWDFLIK platform then all video from his or her performance can be blocked by server 30 from future use. Also, content that is inappropriate for certain audiences can be blocked from those users by server 30. For example, video with foul language can be restricted to users who are above age 13, etc.

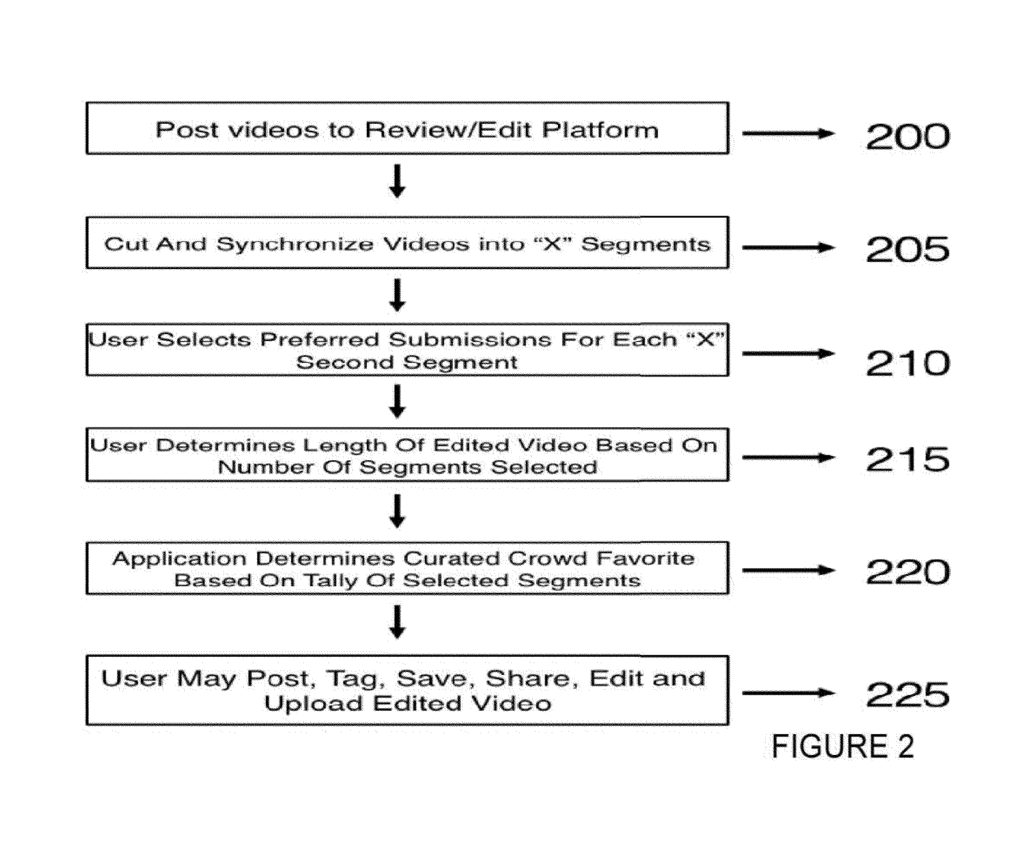

FIG. 2 is a block/flow diagram illustrating an exemplary video capture and submission process of the present system and methods, including the location/date/time tagging and video capture/tag/submission process. The CROWDFLIK Review/Edit platform provides a unique way to edit a video of any event where video has been submitted via the CROWDFLIK app. After a user has captured a video, the captured video can be posted to a review/edit platform at step 200. The submitted videos can be cut, and presented in a time-synchronized manner to allow a user to view all submitted segments for each Y second(s) time period at step 205. A user may select to play the continuous segments from a single submitter, or the user may choose any one of the submitted segments for each Y second(s) time period. Since these Y second(s) pieces were each “cut” or tagged according to the same master clock within the CROWDFLIK app 10, the synchronized reassembly of one submission per time segment creates a unique edit, and plays as a professionally cut and edited video to be viewed, saved, shared, commented on, liked, and rated, as well as reviewed on other popular social media sites.

FIG. 4 is an exemplary screen shot of a Review/Edit Platform similar to that shown in FIG. 5A. The screen shot shows a screen of the present systems, methods, and computer accessible mediums with annotations. In the edit mode, the user can spin clips (e.g., like a slot machine) to select a particular clip. A user can pick a particular clip by setting the clip as the center clip 405. An indication that the clip has been selected may be provided. For example, this clip can be given a “thumbs up” indicia, and it can be tallied as a selected clip. The number of selection tallies may be used to rate and identify popular clips. The user can swipe or scroll to the right to select a particular clip for additional segments, and the user can scroll to the left to reselect a particular clip for a particular segment.

The CROWDFLIK app 10 can be set to allow Y second(s) to be a constant interval throughout a particular captured and edited event or can be set to alternate synchronized values. For example for a wedding event, that is captured and edited via CROWDFLIK, the Y value may be 10 seconds. In this wedding example, each segment is cut into 10 seconds based on the app's master clock. Alternatively, for a sporting event, the Y may be a repeating pattern of 10 seconds/5 seconds/10 seconds/5 seconds. In either or any case, the length of each segment (Y) is applied across all captured video presented on Review/Edit platform 500 for each and all of the multiple sources at that location/time event.

The CROWDFLIK app “cuts” all video captured via the CROWDFLIK app synchronized by the app's master clock to Y second(s) per segment. At step 210 of FIG. 2, a user can select a Y second segment for each position in the video. The user can also select a portion of the entire event video in order to create, save and share shorter videos that are a subset of the overall video of any given location/time event. At step 215, the total length of the video can be determined based on the number of segments that are selected. At step 220, a crowd favorite for each segment can be selected based on the total number of times a segment is selected. The crowd favorite can be dynamically updated as additional segments are selected. The user is given the option to replace their current segment with the crowd favorite if their selection is not the crowd favorite. Once all of the segments have been selected, the edited video can be posted at step 225.

To facilitate the user friendly tap to select or drag and drop editing, the start and end of shorter videos will preferably correspond to a start and end of the Y second(s) segments respectively. An example of this could be selecting a user's edit of a single song from a concert event consisting of many songs or a single series of plays from an entire football game. This mini-edit may also be saved, shared, viewed and re-edited by users who are signed in to their accounts.

The CROWDFLIK app allows for time linear resynchronization or assembly of video segments as well as non-time linear video editing. For example, the user can be permitted to select any submitted video segment and place it anywhere in the video timeline of the user's edit. If a user chooses to drag a video segment into the timeline of his video edit he may do so in any order that he chooses. This allows for video creation and viewing of nonlinear video such as multiple segments from the same Y time slot.

The CROWDFLIK app 10 supports sponsored events via its unique business model whereby the app serves as the connector between fan captured, uploaded, edited, and shared video of an event and the message of the event sponsor venue, act, or other user directed commercial or community based message.

Optionally, the CROWDFLIK app 10's use provides for a unique crowd curated video of each event. As each signed-in user makes, creates and saves a personal edit using one of the systems described previously for FIG. 4, 5A, or 5B (which results in a video clip or “flik”), his or her selection in each time slot across the video timeline and audio timeline (if present) preferably receives a “vote” when the edit is saved by the registered (e.g., signed in) user. The aggregate of these votes for each segment can result in a most voted for, or most selected, submission in each of the Y second(s) time slots. Thus, the aggregate votes allow other users to easily determine which video or audio segments are most popular among the registered users. Each registered user is permitted to create, save and share multiple edits of an event. Each selection of the user can receive one (1) vote. Multiple edits from a registered user may result in multiple submissions in any given time segments receiving votes. A single submission can be limited to no more than one (1) vote per registered user regardless of the number of times that segment appears in the user's various edits. This crowd curated best-of video consists of these submissions, and is the result of a unique process where each user identifies his selection resulting in the best-of listing.

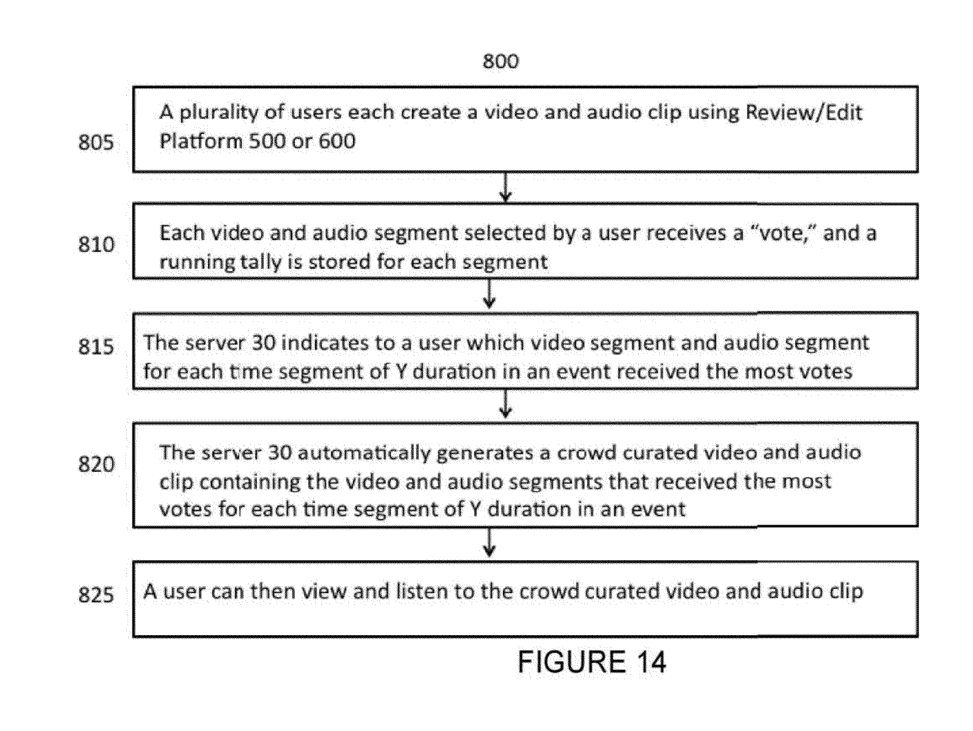

This aspect of the embodiments is shown in FIG. 14. FIG. 14 depicts a method 800 for generating a crowd curated video and audio clip. A plurality of users each create a video and audio clip using Review/Edit Platform 500 or 600 (step 805). Each video and audio segment selected by a user receives a “vote,” and a running tally is stored for each segment (step 810). The server 30 indicates to a user which video segment and audio segment for each time segment of Y duration in an event received the most votes (step 815). The server 30 automatically generates a crowd curated video and audio clip containing the video and audio segments that received the most votes for each time segment of Y duration in an event (step 820). A user can then view and listen to the crowd curated video and audio clip (step 825).

In one embodiment, a user may review and edit video on the CROWDFLIK Review/Edit platform as a guest who has not signed in under an account USER ID. In order to encourage user registration, if a user views and edits as a guest (e.g., not signed in or registered), that user may be provided with limited functionality. For example, the user may be precluded from saving edits for future viewing or the edit selections may be ignored in the overall curation tally for best edit or crowd choice.

In one embodiment, the CROWDFLIK app can allow for the automated insertion of sponsor messages at a pre-determined time slot in between certain Y second(s) segments along the time-line of the edited versions of videos as well as the insertion of pre-roll advertising video or other message from a sponsor, advertiser, or other source.

When a user selects CROWDFLIK through which to capture video, the user is prompted to accept/confirm location and time/date. This is to assure that when the CROWDFLIK app submits the user's captured video, it is correctly submitted based on its time/location (e.g., event) characteristics. However, the entry of the time/location information can be performed either prior to, during, or after, video capture. For example, the CROWDFLIK app allows for registered users to capture video prior to confirming location or joining an event, and will prompt the user to select event/location after the capture of video via the CROWDFLIK app.

In one embodiment, the CROWDFLIK app includes algorithms to assess location and time sameness among various submissions. The CROWDFLIK app can also determine if other users are in the vicinity of a signed in user. In a further embodiment, the CROWDFLIK app can notify a user upon location confirmation of nearby friends and/or other CROWDFLIK users.

When the user captures and submits video via CROWDFLIK app 10, the video is also saved on the smart phone camera roll of device 20 just as it would be if it were not captured through CROWDFLIK app 10. The saved video is not cut or altered by CROWDFLIK app 10. CROWDFLIK app 10 allows a user to review each captured video segment and decide or confirm to upload to server 30.

Preferably, the CROWDFLIK app uploads a thumbnail of each video segment as well as the user id of the capturer for easier user identification and review. In one embodiment, the CROWDFLIK app uses the Refactor Video Upload service, or another upload service or protocol, to ensure that the user Id and event Id provided by a user represent real data, and limits the creation of a video record to only occur after a video file and thumbnail was uploaded.

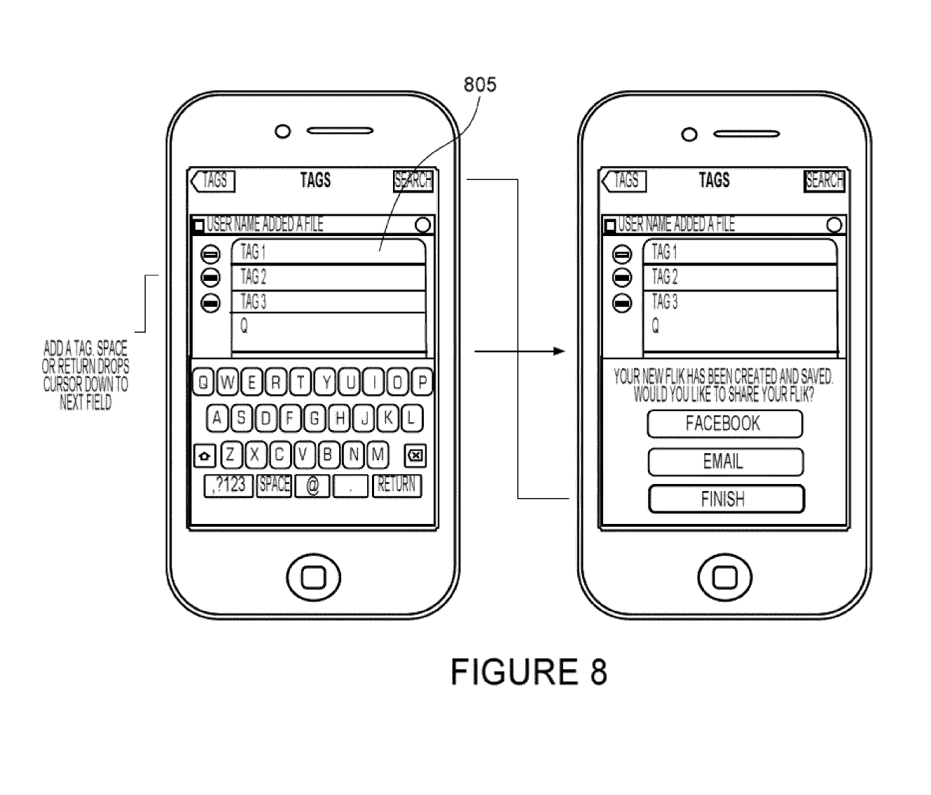

When a user creates an edit in the Review/Edit function, the user is able to attach tags 809 to further define the edit or content for later search purposes, as shown in FIG. 8. As illustrated in FIG. 8, the user can also share the edit with others using social media, such as Facebook, or by distributing to one or more individuals by email or text transmission (e.g., short messages service).

CROWDFLIK is a unique video capture and edit mobile and Internet platform that allows multiple users to submit video, and to create unique edits from the aggregate of multiple submitted videos; the CROWDFLIK app achieves this via synchronized tagging with location/time/event stamp at the time of capture, which assures that all video posted to the CROWDFLIK Review/Edit platform for subsequent review and edit is video from matched events based on location, and is synchronized for edit based on the CROWDFLIK app master clock; the synchronized video is searchable based on the time/location tag. In one embodiment, users can select multiple events to be presented on the review/edit platform in order to create a collage-type video. This also allows users to combine multiple CROWDFLIK events of the same real-life event in order to have access to all video captured at that real-life event. If there are multiple CROWDFLIK events of the same real-life event, each of the event creators may agree via the CROWDFLIK app 10 to combine their events to reduce confusion. This might happen, for example, at an event that physically exceeds the established geofence. For example, the presidential inauguration often spans over a mile in physical distance. If the geofence is set for 100 yards, the server may allow the creation of multiple events corresponding to the single real-life event (the presidential inauguration).

The CROWDFLIK app 10 uses a variety of inputs and methods to determine the optimal length for segments of captured video to be cut into for synchronized review and edit at the CROWDFLIK Review/edit platform. This length “Y” synchronized review/edit. The value Y may be in repeating patterns of unequal time segments—such as 10-5-10-5-10-5 seconds, etc. or in single segment length throughout the capture—such as 15-15-15-15 seconds, etc. The CROWDFLIK method of cutting submitted video into Y second(s) pieces allows for a simple and powerful process to create, view, save and share multiple edits based on the selection of a preferred submission for each of the Y second(s) time slots which then seamlessly re-synchronize back together to create a professional quality video consisting of multiple sequential clips of video pieces of lengths of Y second(s).

The CROWDFLIK app 10 tallies the aggregate of the multiple users' selections of segments to create their own edit, which results in a top ranked submission for each Y second(s) time slot. The aggregate of the most selected segments determines the best-of edit as curated by the crowd. To prevent and/or limit gaming, the CROWDFLIK app 10 applies certain methods and analysis to the curation process to determine the best-of edit. The vote tally may change as additional users create edits which will result in the best-of edit to change over time.

The CROWDFLIK app allows for unique sharing and posting of unique edits of videos created from submissions from multiple users and edited by a single user or multiple users.

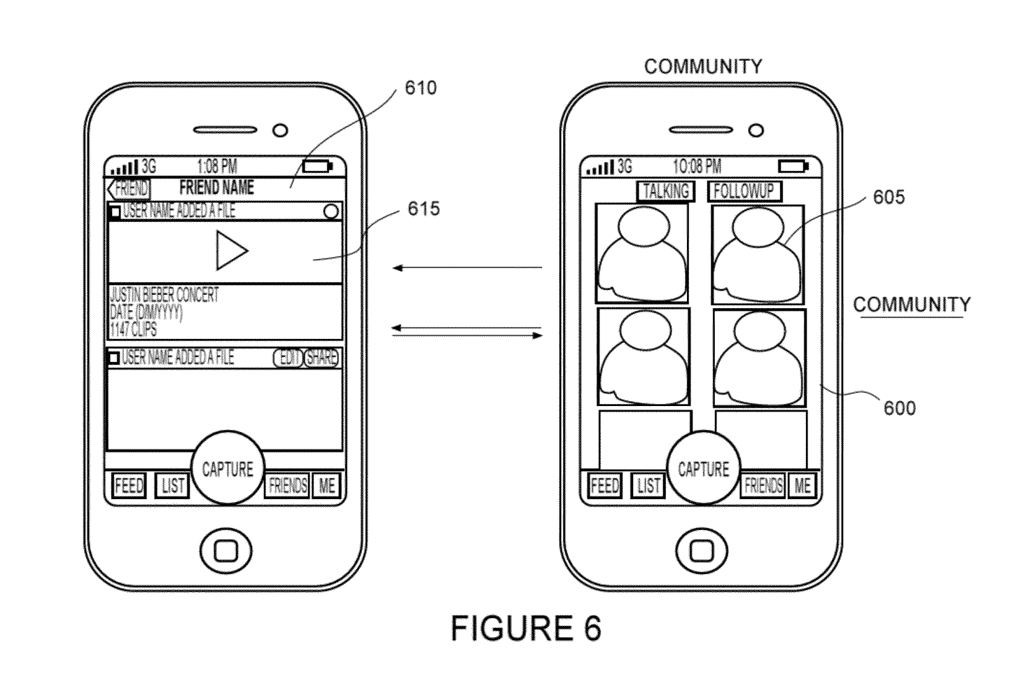

FIG. 6 represents screen flow enabling a user to follow other CROWDFLIK users and their edits. Once a user logs in to the CROWDFLIK app 10, the user can select a particular friend 600 from a community 605. The user is then taken to the friend's page 610, to see all of the friend's videos 615. The user can subscribe to their friend's page, and can receive automatic updates if their friend posts a new video.

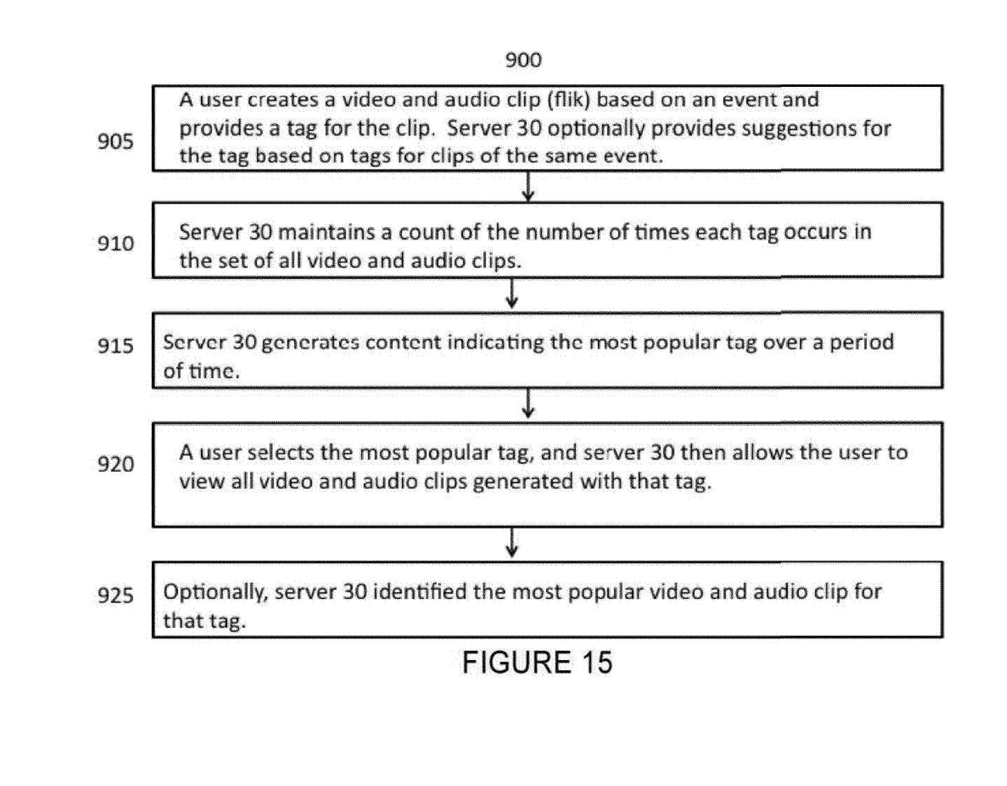

Another aspect of the embodiments described herein is shown in FIG. 15, which depicts a method 800 for displaying trending data for video and audio clips (fliks) created using the embodiments described herein. A plurality of users each create a video and audio clip using Review/Edit Platform 500 or 600 (step 805). Each video and audio segment selected by a user receives a “vote,” and a running tally is stored for each segment (step 810). The server 30 indicates to a user which video segment and audio segment for each time segment of Y duration in an event received the most votes (step 815). The server 30 automatically generates a crowd curated video and audio clip containing the video and audio segments that received the most votes for each time segment of Y duration in an event (step 820). A user can then view and listen to the crowd curated video and audio clip (step 825).

Notably, a user of the systems of FIGS. 4, 5A, and 5B need not have been the creator of any video or audio streams to use the system. That is, a user can access the Review/Edit Platform 500 or 600 from server 30, optionally by searching for a specific topic or event using tags or other metadata. All non-private events will be accessible from server 30 and an unlimited number of video and audio clips (fliks) can be generated for non-private events.

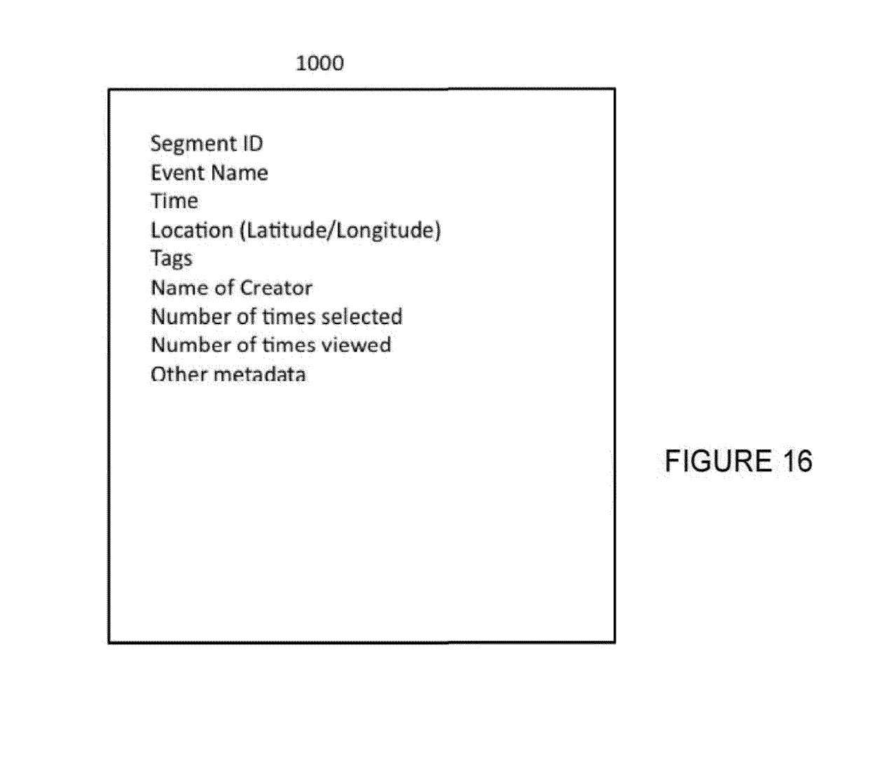

FIG. 16 depicts a data structure 1000 that optionally can be generated by server 30 for each segment of each video or audio stream. Data structure 1000 optionally can include fields for one or more of the following: a unique identifier for the segment (Segment ID), Event Name, Time, Location (Latitude/Longitude), Tags, Name of Creator, Number of times selected, Number of times viewed, and any other metadata associated with the segment.

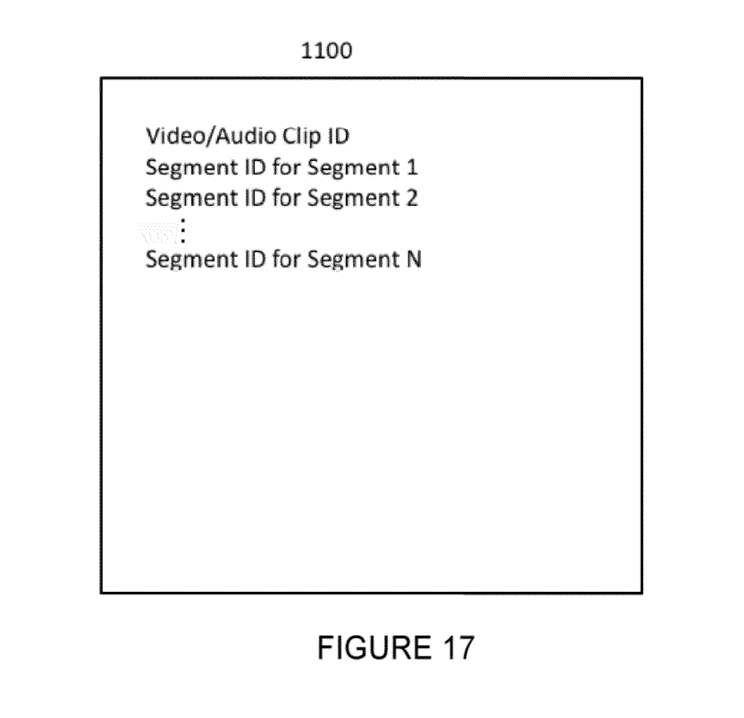

FIG. 17 depicts a data structure 1100 that optionally can be generated by server 30 for each video or audio clip. Data structure 1100 optionally is a playlist or other structure that can include the following: a unique ID for the clip (a Video/Audio Clip ID), the Segment ID for the Segment 1 (the first segment in the clip), the Segment ID for Segment 2, and a Segment ID for all other segments in the clip, ending with the Segment ID for Segment N, where N is the number of segments in the clip.

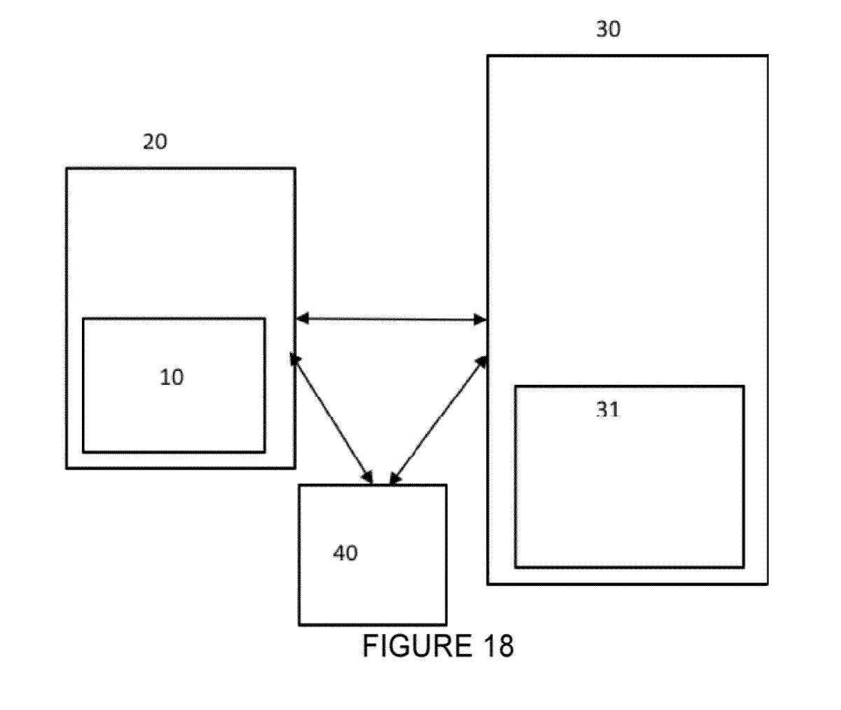

FIG. 18 depicts device 20 running CROWDFLIK app 10, coupled to server 30 and reliable clock 40 over a network. Server 30 comprises video store 31, which optionally stores all video streams, audio streams, video segments, audio segments, video clips, and audio clips used by the embodiments described herein. Video store 31 optionally comprises database tables that link each video and audio segment to its Segment ID and data structure 1000 and each video and audio clip to its Video/Audio Clip ID and to data structure 1100. Reliable clock 40 can serve as the master clock described previously.

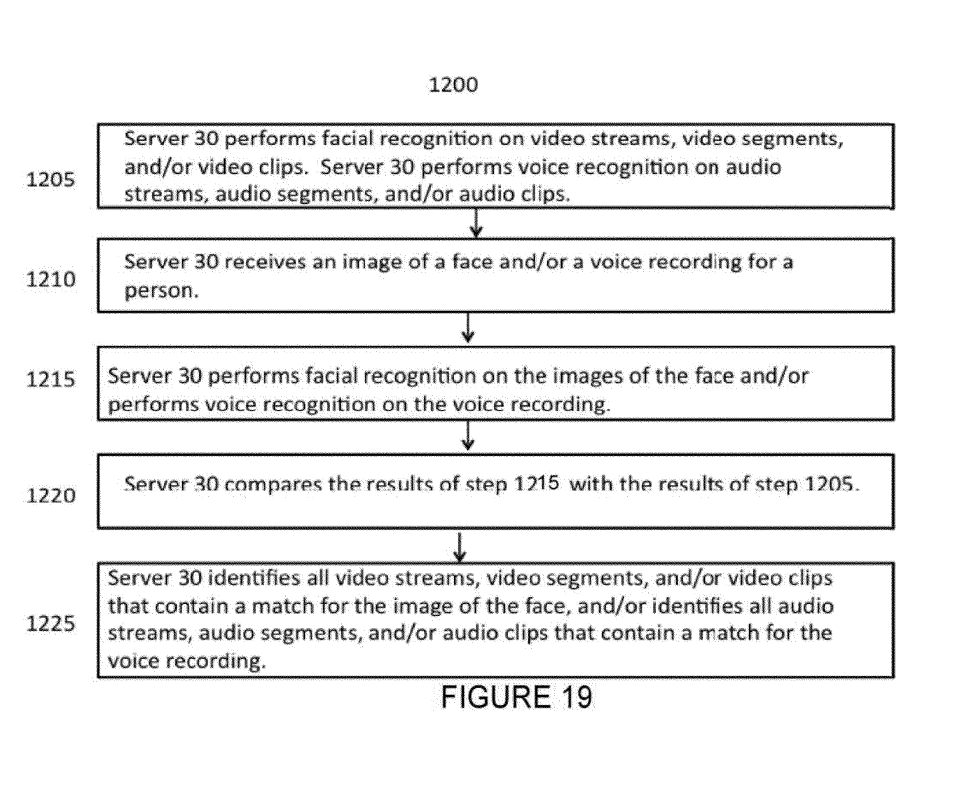

FIG. 19 depicts an embodiment of facial recognition and voice recognition method 1200. Server 30 performs facial recognition on video streams, video segments, and/or video clips. Server 30 performs voice recognition on audio streams, audio segments, and/or audio clips (step 1205). Server 30 receives an image of a face and/or a voice recording for a person (step 1210). Server 30 performs facial recognition on the images of the face and/or performs voice recognition on the voice recording (step 1215). Server 30 compares the results of step 1251 with the results of step 1205 (step 1220). Server 30 identifies all video streams, video segments, and/or video clips that contain a match for the image of the face, and/or identifies all audio streams, audio segments, and/or audio clips that contain a match for the voice recording (step 1225). This method can be useful, for example, in finding missing persons. A user can upload a photograph of the missing person and then instruct server 30 to perform method 1200. The result of method 1200 potentially is video (correlated with time and location information) containing that person's face, and/or audio (correlated with time and location information) containing that person's voice. This method also can provide search capability more generally and will allow a user to perform non-textual searches within video and audio content using a photograph of a face and/or a voice recording.

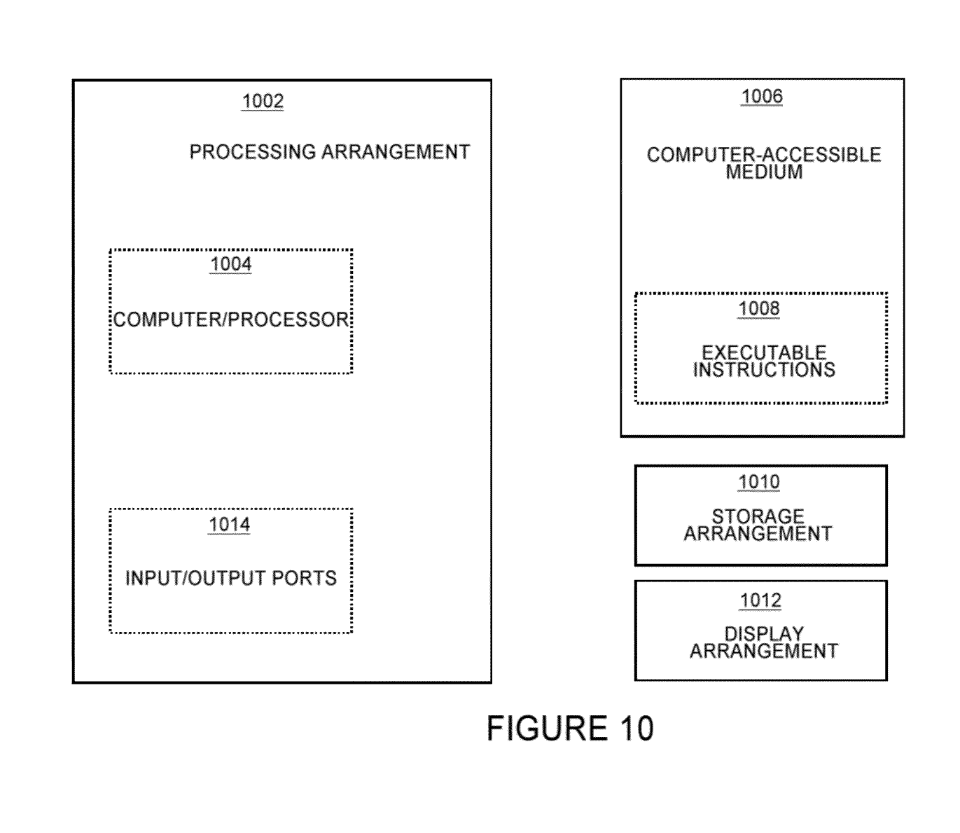

FIG. 10 shows a block diagram of an exemplary embodiment of a system, typically in the form of mobile telephone, smart phone, tablet, or other processing and communication device, according to the present disclosure. For example, exemplary procedures in accordance with the present disclosure described herein can be performed by a processing arrangement and/or a computing arrangement 1002. Such processing/computing arrangement 1002 can be, for example, entirely or a part of, or include, but not limited to, a computer/processor 1004 that can include, for example, one or more microprocessors, and use instructions stored on a computer-accessible medium (e.g., RAM, ROM, hard drive, or other storage device).

As shown in FIG. 10, for example, a computer-accessible medium 1006 (e.g., as described herein above, a storage device such as a hard disk, floppy disk, memory stick, CD-ROM, RAM, ROM, etc., or a collection thereof) can be provided (e.g., in communication with the processing arrangement 1002). The computer-accessible medium 1006 can contain executable instructions 1008 thereon that implement, inter alia, the CROWDFLIK application software. In addition or alternatively, a storage arrangement 1010 can be provided separately from the computer-accessible medium 1006, which can provide the instructions to the processing arrangement 1002 so as to configure the processing arrangement to execute certain exemplary procedures, processes and methods, as described herein above, for example.

Further, the exemplary processing arrangement 1002 can be provided with or include an input/output arrangement 1014, which can include, for example, a wired network, a wireless network, the internet, an intranet, a data collection probe, a sensor, etc. As shown in FIG. 10, the exemplary processing arrangement 1002 can be in communication with an exemplary display arrangement 1012, which, according to certain exemplary embodiments of the present disclosure, can be a touch-screen configured for inputting information to the processing arrangement in addition to outputting information from the processing arrangement, for example. Further, the exemplary display 1012 and/or a storage arrangement 1010 can be used to display and/or store data in a user-accessible format and/or user-readable format, in a manner well known in the art.

An embodiment will now be described that provides the ability to capture video from a variety of devices, to store the video and associated metadata, to retrieve video and associated metadata, to parse the video and metadata using a plurality of different criteria, to output collections of video based on those or other criteria, and to retrieve the collections at a later time. This embodiment provides an enhanced video capture, cataloging, and output capability.

The embodiment would be useful, for example, for law enforcement officials who wish to capture real-time video from officers in the field, stationary cameras on buildings, cameras mounted in cars or on drones, or other sources; to organize that video based on criteria such as location (e.g., scene of a crime); and to provide output files containing portions of the video (e.g., all video clips regarding a particular incident).

The embodiment will include optional features such as facial recognition, image recognition, and sound recognition and the ability to pixelate or obfuscate faces, which can be useful for protecting the privacy of minors or eye witnesses or other objects present in the video that the user feels should be obfuscated.

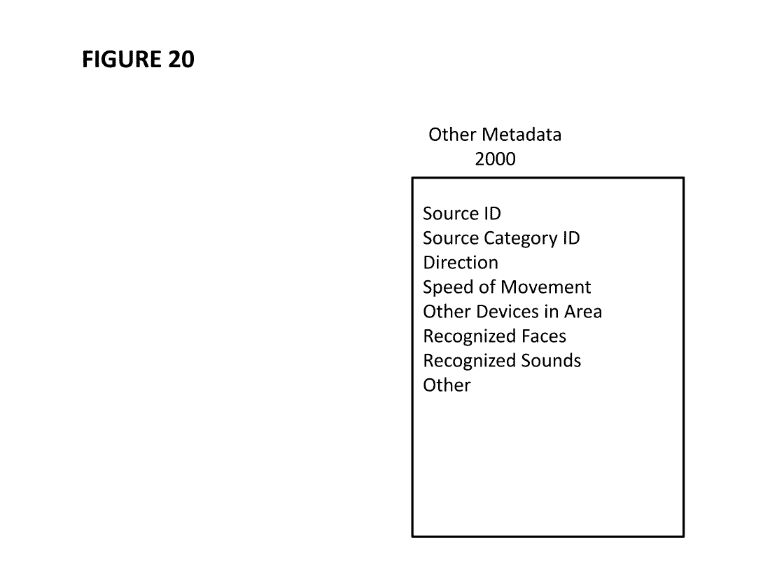

FIG. 20 depicts examples of Other Metadata 2000. Other Metadata 2000 can be stored in data structure 1000 in the “other metadata” field described above with reference to FIG. 10. Here, Other Metadata 2000 can comprise Source ID, Source Category ID, Direction, Speed of Movement, Other Devices in Area, Recognized Faces, Recognized Sounds, and Other. Source ID can be an identifier for a camera, Source Category can be the type of camera, Direction indicates the direction of movement of the camera, Speed of Movement indicates the speed of movement of the camera, Other Devices in Area indicates the Source IDs for other devices that were detected in the area at the time of video capture, or which are later determined to have been in that area at the time of video capture, Recognized Faces can be data indicating the identity of a person who is recognized as a result of a facial recognition algorithm, Recognized Sounds can be a description or identifier for a sound (such as a voice) that is recognized as a result of a sound recognition algorithm, and Other can store other data of interest.

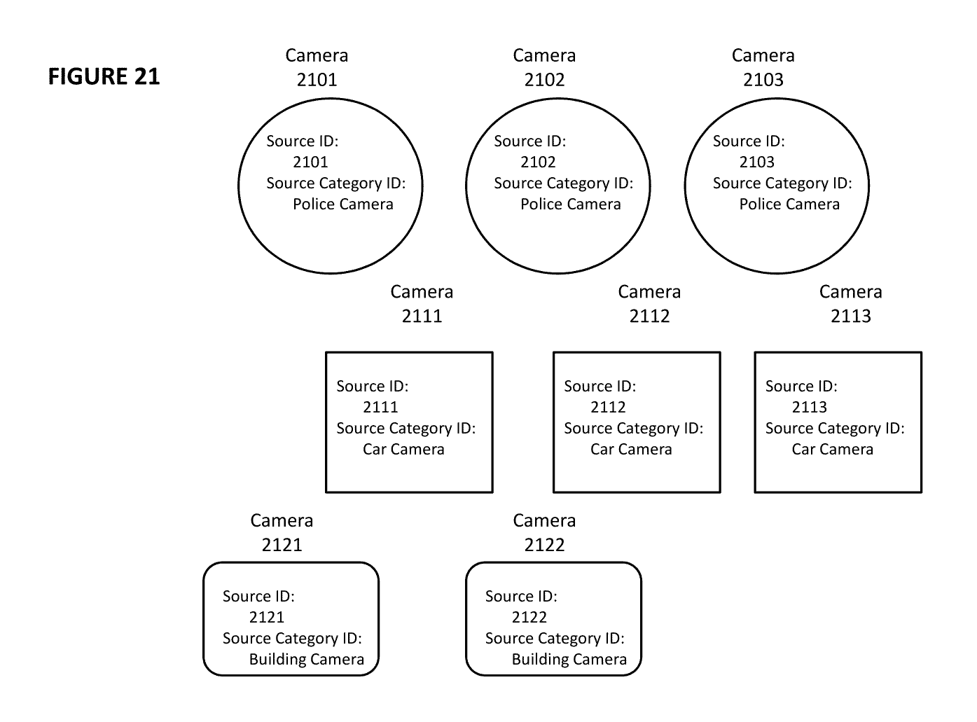

FIG. 21 shows an exemplary set of cameras and their associated Source IDs and Source Category IDs for a law enforcement department. In this example, three police officers each carry a body-mounted camera (cameras 2101, 2102, and 2103), three police cars each carry a car-mounted camera (cameras 2111, 2112, and 2113), and two stationary cameras are mounted on buildings (cameras 2121 and 2122). For cameras 2101, 2102, and 2103, the source IDs are 2101, 2102, and 2103, respectively, and the Source Category ID for each is Police Camera. For cameras 2111, 2112, and 2113, the Source IDs are 2111, 2112, and 2113, respectively, and the Source Category ID for each is Car Camera. For cameras 2121 and 2122, the Source IDs are 2121 and 2122 and the Source Category ID for each is Building Camera.

Any number of Source Category IDs is possible. In the law enforcement example, a non-exhaustive list of possible Source Category IDs is shown in Table 1:

TABLE 1
Examples of Source Category IDs

| Source Category ID | Purpose |
|---|---|
| Police Camera | Mount on police officer |
| Car Camera | Mount in police car |
| Building Camera | Mount on building |
| Drone Camera | Mount on drone |
| Helicopter Camera | Mount on helicopter |
| Traffic Light Camera | Mount on traffic light |
| Citizen Camera (e.g., smartphone) | Held by person |
| Motorcycle Camera | Mount on motorcycle |
| Action Camera | Mount on moving person or object |
| Any other device capturing video, | Capture video, audio, photos, or |
| audio, photos, or any combination | any combination thereof |
| thereof | |

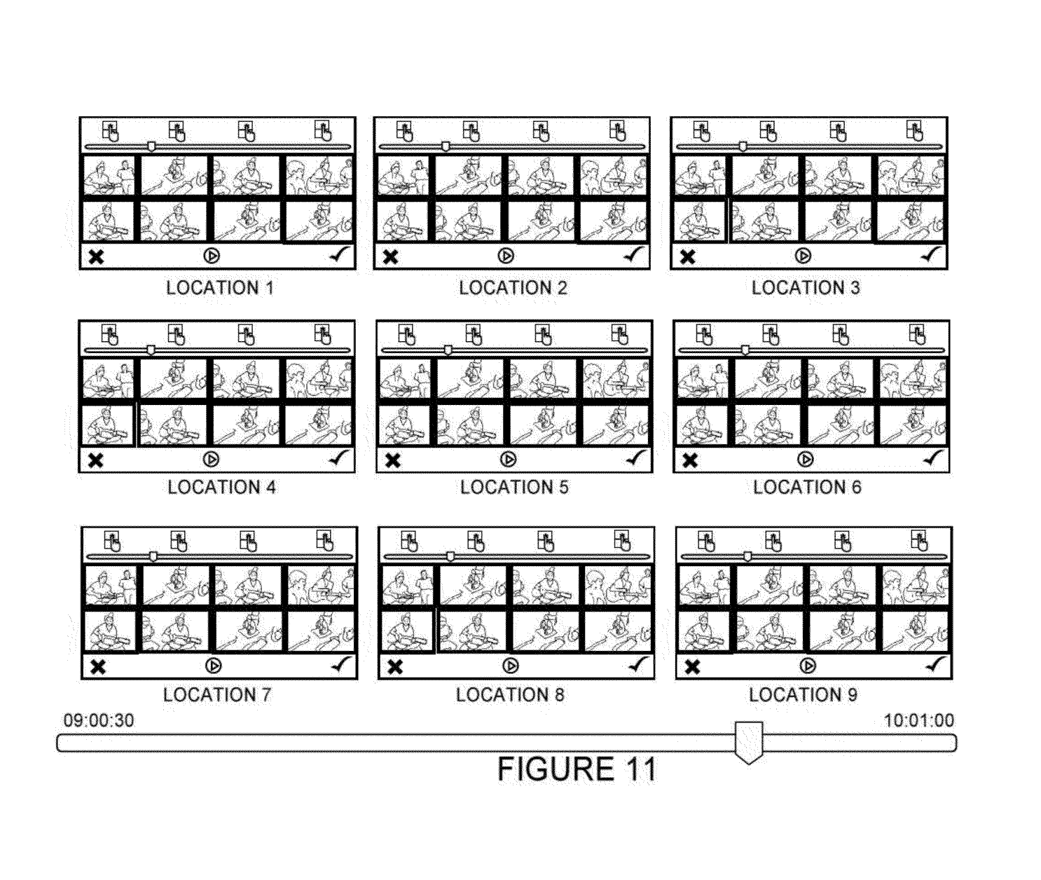

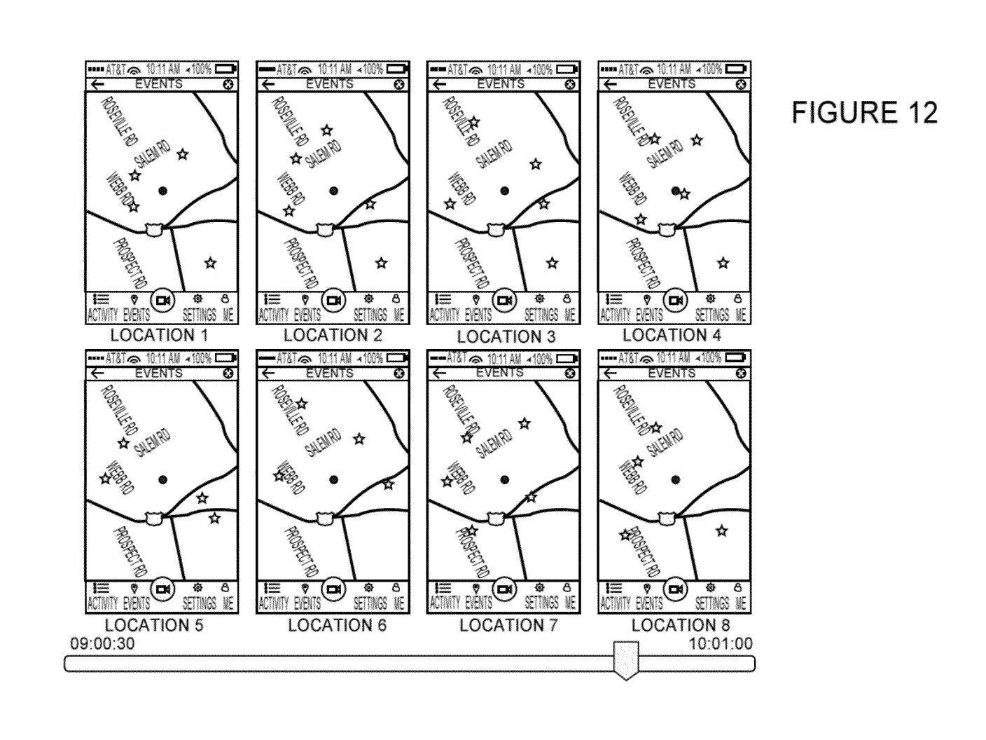

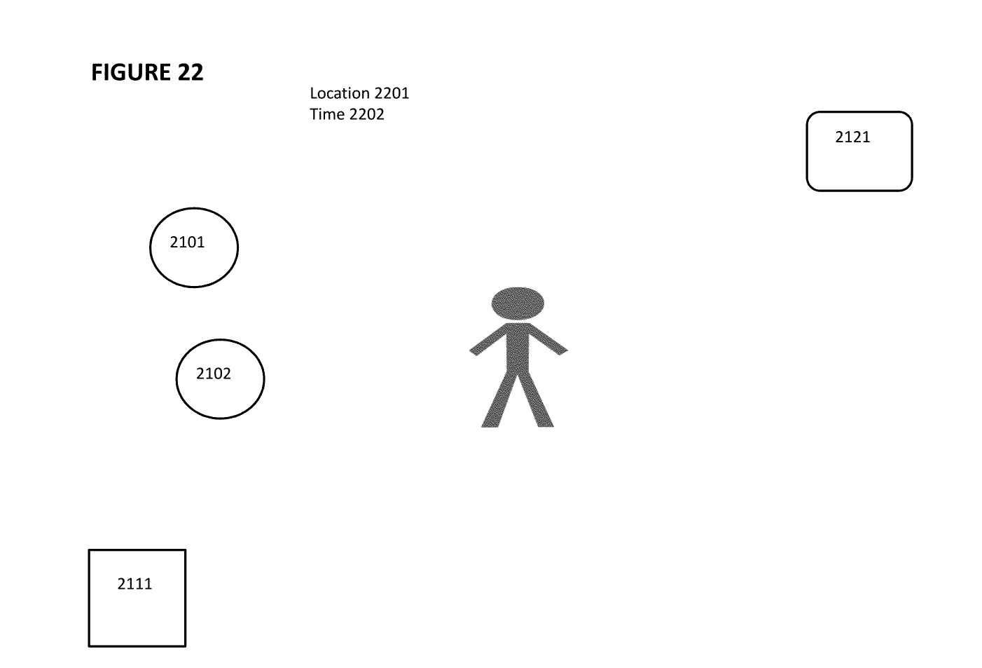

FIG. 22 depicts a usage of this embodiment to capture and organize video of an event near location 2201 at time 2202. An incident occurs involving the person shown in FIG. 22. Camera 2121 is mounted on a building (such as a bank building). Cameras 2101 and 2102 are mounted on two police officers who arrive at the scene (location 2201). Camera 2111 is mounted in their police care. Using the embodiments previously described with reference to FIGS. 1-19, video is captured from each of those cameras, an instantiation of data structure 1000 is created for each video stream, and the video is synchronized. In other words, the same location and time synchronization feature described for previous embodiments can be used in the situation depicted in FIG. 22.

In other instances, for example, where the relevant event moved locations or transpired over a relatively long period of time, it may be useful to organize the video segments using criteria other than just time or location. For example, one might wish to see all video taken at a particular location over an entire week, or all video taken by a particular police officer on a particular day as well as all video taken by that police officers car camera. For a particular event, the user could select or unselect sources by Source ID or Source Category ID when viewing and/or editing video clips, to allow the user to view and/or edit, for example, only video captured by Police Cameras.

After the user identifies the criteria of interest, server 30 and video store 31 can identify and output all video that meets the particular criteria that is based on data stored in data structure 1000. For example, the user can instruct server 30 to identify all video segments based on one or more of: Event Name, Time, Location, Tags, Name of Creator, Source ID, Source Category ID, Direction, Speed of Movement, Other Devices in Area, Recognized Faces, Recognized Sounds, and Other. The original source video is unaltered by the viewing and editing process.

In one user interface implementation, a geographic map can be shown with dots showing cameras, where the dots can move over time, and the video segments captured by each camera can be shown above the map.

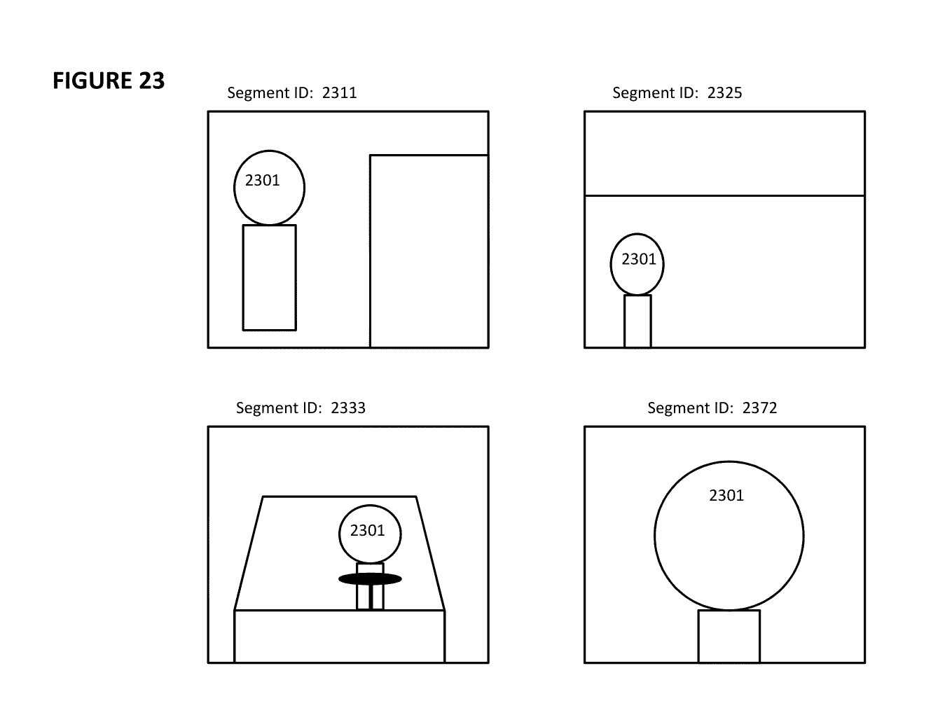

With reference to FIG. 23, another embodiment is shown. Here, facial recognition algorithms (which are known in the prior art) are run on all or a subset of captured video. When a face is recognized, the name for that person is stored in the “Recognized Faces” field of Other Metadata 2000. A law enforcement unit could do this, for example, for a list of “Most Wanted” criminals, or for a particular perpetrator they are trying to locate. After the facial recognition algorithm is run, all video clips containing the face of interest (e.g., all video clips with “Joe Smith” listed in the Recognized Faces field of Other Metadata 2000) can be identified and shown in the video editing platforms previously described. A police officer or other person can then review each video clip and create a file or structure containing the video clips of interest. In FIG. 23, four segments involving a particular face corresponding to Recognized Faces data 2301 (e.g., the name “Joe Smith”) are detected. The video clip corresponding to Segment ID 2311 shows the perpetrator entering a building. The video clip corresponding to Segment ID 2325 shows the perpetrator walking at a train station. The video clip corresponding to Segment ID 2301 shows the perpetrator driving car. The video clip corresponding to Segment ID 2372 shows a close-up shot of the perpetrator.

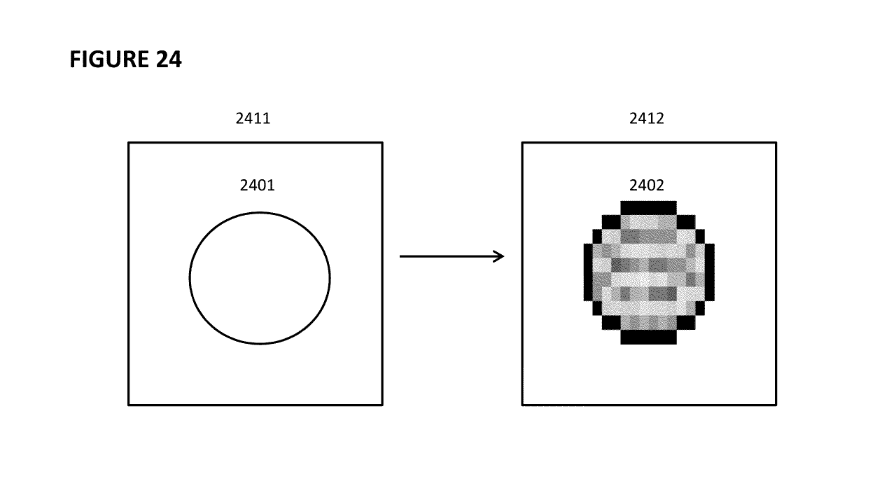

With reference to FIG. 24, the platform will allow faces to be obfuscated, either manually by a police officer selecting a face to be obfuscated in a video clip, or automatically as a result of the facial recognition algorithms. Here, a face 2401 in video clip 2411 is pixelated to create obfuscated face 2402 in video clip 2412, where video clip 2412 is a copy of video clip 2411 in all other respects. Video clip 2411 is not altered through this process.

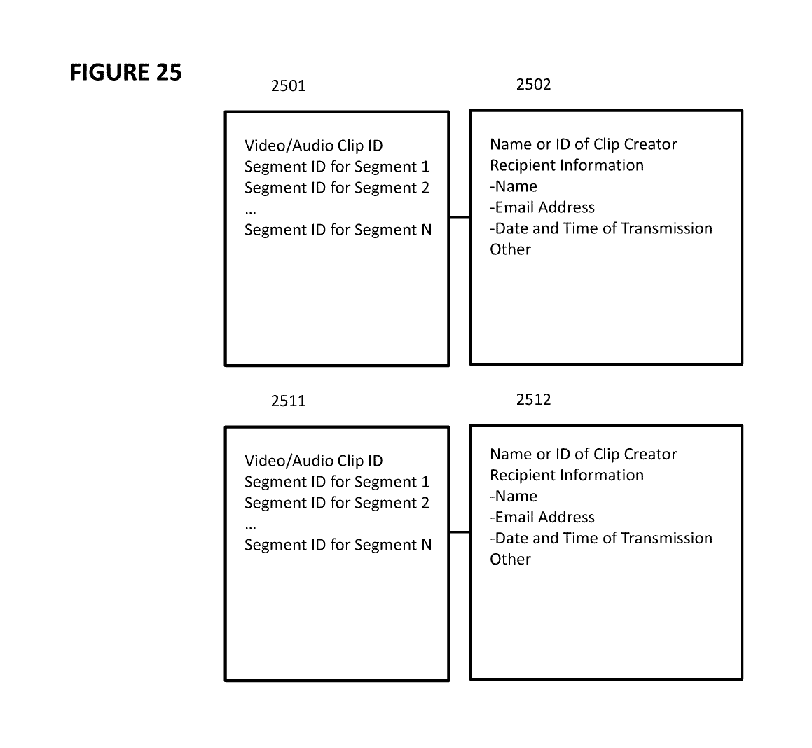

FIG. 25 depicts a mechanism for organizing video clips and creating a new clip or file containing the video clips of interest. The original source video is unaltered by this process, and instead, one or more copies are created for the new clip or file. Here, a person has created a video clip associated with data structure 2501, which has a Video/Audio Clip ID and a Segment ID for each segment of video in that structure. Data structure 2501 is associated with data structure 2502, which indicates the Name or ID of the Clip Creator, the name, email address, and data and time of transmission for the recipient, and other data. Data structure 2511 and 2512 are similar structures for another clip.

Each video clip package optionally can comprise additional attributes: (1) certain data in each segment may be turned on or off; (2) unique permissions as to who can view the package; (3) unique watermarks (digital and traditional) to track sharing, copying, etc.; (4) ability to ‘black-out’ or pixelate portions of audio or video within each ‘X second segment’; and (5) Ability to allow or limit edit/creation/share functionality on video in package.

These features will be particularly useful to law enforcement agencies, which in recent years have been inundated with requests under the Freedom of Information Act (FOIA) for all video related to a certain person or event. Using prior art systems, a person would need to manually collect all relevant video, view them one at a time, and then use crude video editing software to piece different portions together. There was no way to systematically keep track of which video segments were used, where they originated, how they were captures, and to whom they were given. The mechanism of FIG. 25 and the platform described above for previous embodiments solves this drawback in the prior art.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A method of handling video, comprising:
capturing, by a first device comprising a first camera, a first video and associated time information indicating the time when the capturing of the first video commenced;
capturing, by a second device comprising a second camera, a second video and associated time information indicating the time when the capturing of the second video commenced;
storing the first video and associated time information and identification data for the first device;
storing the second video and associated time information and identification data for the second device;
receiving search criteria;
displaying a first set of video clips from the first video and a second set of video clips from the second video in a time-synchronized manner in response to the search criteria;
generating a first video file comprising a portion of the first set of video clips and a portion of the second set of video clips; and
storing the first video file.

2. The method of claim 1, wherein the time information associated with the first video and the time information associated with the second video are generated based on the same clock;

3. The method of claim 1, wherein the search criteria comprises one or more of: identification data for the device, identification data for the person who used the device, category of the device, and location of the device when video was captured.

4. The method of claim 1, further comprising: disseminating the first video file.

5. The method of claim 1, wherein the first device is mounted on a first person and the second device is mounted on a second person.

6. The method of claim 1, wherein the first device is mounted on a first person and the second device is mounted on a stationary object.

7. The method of claim 1, further comprising:
generating a second video file comprising a portion of the first set of video clips and a portion of the second set of video clips; and
storing the second video file.

8. The method of claim 7, further comprising:
disseminating the first video file; and
disseminating the second video file.

9. The method of claim 1, further comprising:
pixelating one or more images in the portion of the first set of video clips and a portion of the second set of video clips before storing the first video file.

10. A method of handling video, comprising:
capturing, by a first device comprising a first camera, a first video and associated time information indicating the time when the capturing of the first video commenced and associated location information indicating the location where the capturing of the first video occurred;
capturing, by a second device comprising a second camera, a second video and associated time information indicating the time when the capturing of the second video commenced and associated location information indicating the location where the capturing of the second video occurred;
storing the first video and associated time information, associated location information, and identification data for the first device;
storing the second video and associated time information, associated location information, and identification data for the second device;
receiving search criteria, the search criteria comprising location information and time information;
displaying a first set of video clips from the first video and a second set of video clips from the second video in a time-synchronized manner in response to the search criteria;
generating a first video file comprising a portion of the first set of video clips and a portion of the second set of video clips; and
storing the first video file.

11. The method of claim 10, wherein the time information associated with the first video and the time information associated with the second video are generated based on the same clock;

12. The method of claim 10, wherein the search criteria further comprises one or more of: identification data for the device, identification data for the person who used the device, category of the device, and location of the device when video was captured.

13. The method of claim 10, further comprising: disseminating the first video file.

14. The method of claim 10, wherein the first device is mounted on a first person and the second device is mounted on a second person.

15. The method of claim 10, wherein the first device is mounted on a first person and the second device is mounted on a stationary object.

16. The method of claim 10, further comprising:
generating a second video file comprising a portion of the first set of video clips and a portion of the second set of video clips; and
storing the second video file.

17. The method of claim 16, further comprising:
disseminating the first video file; and
disseminating the second video file.

18. The method of claim 10, further comprising:
pixelating one or more images in the portion of the first set of video clips and a portion of the second set of video clips before storing the first video file.

19. A method of handling video, comprising:
capturing a plurality of video clips by a plurality of cameras;
storing the plurality of video clips in a storage device;
performing facial recognition on the plurality of video clips to generate a list of faces contained in the plurality of video clips;
identifying a subset of the plurality of video clips, based on the list of faces, that contain the same face;
generating a video file comprising at least a portion of the subset of the plurality of video clips; and
storing the first video file.

20. The method of claim 19, further comprising: disseminating the first video file.
